(19) United States
(12) Patent Application Publication
(10) Pub. No.: US 2022/0068276 A1
(43) Pub. Date: Mar. 3, 2022

(54) INFORMATION PROCESSOR, PRINT SYSTEM, AND CONTROL METHOD

(71) Applicant: SHARP KABUSHIKI KAISHA, Sakai City (JP)

(72) Inventor: HIROKI MUNETOMO, Sakai City (JP)

(21) Appl. No.: 17/462,961

(22) Filed: Aug. 31, 2021

(30) Foreign Application Priority Data
Sep. 1, 2020 (JP) 2020-147119

(51) Int. Cl. G10L 15/22; G06F 16/58; G06F 16/54; G06F 16/14; H04N 1/00

(52) U.S. Cl. CPC G10L 15/22; G06F 16/5866; G10L 2015/223; G06F 16/148; H04N 1/00403; G06F 16/54

(57) ABSTRACT

An acquirer that acquires a keyword recognized from an input first voice, a narrower that narrows down a file by using the keyword, a voicing processor that executes a process of voicing a voicing content which is based on the file narrowed down by the narrower, and an identifier that identifies the file based on a second voice inputted after the voicing content is voiced are provided.

### BACKGROUND OF THE INVENTION

### Field of the Invention

The present disclosure relates to an information processor and the like.

### Description of the Background Art

Conventional technologies for operating a device by voice are known. For example, there has been proposed an image former which compares a to-be-input voice with an already registered voice, and controls, based on the result of the comparison, invocation of an image forming mode caused to correspond to the input voice (see, for example, Japanese Unexamined Patent Application Publication No. 2000-181292). In addition, there is proposed a man-machine interface device which displays, in characters, a to-be-voiced keyword for voice recognition, serial numbers for identification or the like on or near a selectable object on a GUI (graphical user interface) screen (see, for example, Japanese Unexamined Patent Application Publication No. 2000-267837).

The arts disclosed in Japanese Unexamined Patent Application Publication No. 2000-181292 and Japanese Unexamined Patent Application Publication No. 2000-267837 cause the voice to correspond to the mode and function that the device has, and do not take into account the case of selecting a file. There is a problem that, when selecting the file, with a long file name, it takes time and effort for the user to read out the file. In addition, there is a problem that it is difficult to read the file name, such as the case where the file name includes symbols and/or alphabets.

In view of the above problems, it is an object of the present disclosure to provide an information processor and the like capable of appropriately identifying a file by a voice operation.

### SUMMARY OF THE INVENTION

For solving he above problem, an information processor of the present disclosure, includes: an acquirer that acquires a keyword recognized from an input first voice; a narrower that narrows down a file by using the keyword; a voicing processor that executes a process of voicing a voicing content which is based on the file narrowed down by the narrower; and an identifier that identifies a file based on a second voice inputted after the voicing content is voiced.

A print system of the present disclosure, includes: an information processor; and an image former, wherein the information processor includes: an acquirer that acquires a keyword recognized from an input first voice, a narrower that, by using the keyword, narrows down a file which the image former can output, a voicing processor that executes a process of voicing a voicing content which is based on the file narrowed down by the narrower, and a file identifier that identifies a file based on a second voice inputted after the voicing content is voiced, wherein the image former includes: a predetermined image former for forming an image of the file identified by the file identifier.

A control method of the present disclosure, includes: acquiring a keyword recognized from an input first voice; narrowing down a file by using the keyword; executing a process of voicing a voicing content which is based on the file narrowed down; and identifying a file based on a second voice inputted after the voicing content is voiced.

According to the present disclosure, it is possible to properly identify a file by a voice operation.

### BRIEF DESCRIPTION OF THE DRAWINGS

FIG. 1 is a diagram for explaining an overall configuration of a system according to a first embodiment.

FIG. 2 is a diagram explaining the functional configuration of a voice inputter/outputter in the first embodiment.

FIG. 3 is a diagram explaining the functional structure of a voice recognition server in the first embodiment.

FIG. 4 is a diagram explaining the functional structure of a dialogue server in the first embodiment.

FIG. 5 shows an example of a data structure of a determination table in the first embodiment.

FIG. 6 shows an example of a data structure of accumulated file information in the first embodiment is shown.

FIG. 7 is a diagram for explaining a functional configuration of an image former in the first embodiment.

FIG. 8 is a sequence diagram for explaining a flow of processes in the first embodiment.

FIG. 9 is a sequence diagram for explaining a flow of processes in the first embodiment.

FIG. 10 is a flow diagram for explaining the flow of the file name voicing process in the first embodiment.

FIG. 11 is a flow diagram for explaining the flow of thumbnail displaying process in the first embodiment.

FIG. 12 is a diagram for explaining an operation example in the first embodiment.

FIGS. 13A to 13C are diagrams for explaining the operation example in the first embodiment.

FIG. 14 is a diagram for explaining the operation example in the first embodiment.

FIG. 15 shows an example of the data structure of the determination table in a second embodiment.

FIG. 16 is a sequence diagram for explaining a flow of processes in the second embodiment.

FIG. 17 is a flow diagram for explaining the flow of the file narrowing down process in the second embodiment.

FIG. 18 is a flow diagram for explaining the flow of the file name voicing process in the second embodiment.

FIG. 19 is a flow diagram for explaining the flow of the file displaying process in the second embodiment.

FIG. 20 is a diagram for explaining an operation example in the second embodiment.

FIGS. 21A to 21C are diagrams for explaining the operation example in the second embodiment.

FIG. 22 is a sequence diagram for explaining a flow of processes in a third embodiment.

FIG. 23 is a flow diagram for explaining the flow of a compound narrowing down process in the third embodiment.

FIG. 24 is a flow diagram for explaining the flow of the file name voicing process in the third embodiment.

FIG. 25 is a flow diagram for explaining the flow of a thumbnail displaying process in the third embodiment.

FIG. 26 is a flow diagram for explaining the flow of the thumbnail displaying process in the third embodiment.

FIGS. 27A to 27C are diagrams for explaining an operation example in the third embodiment.

### DESCRIPTION OF THE PREFERRED EMBODIMENTS

An embodiment for implementing the present disclosure will be explained below with reference to the drawings. The following embodiments are examples for explaining the present disclosure, and the technical scope of the invention explained in the claims is not limited to the following description.

### 1. First Embodiment

1.1 Overall Configuration

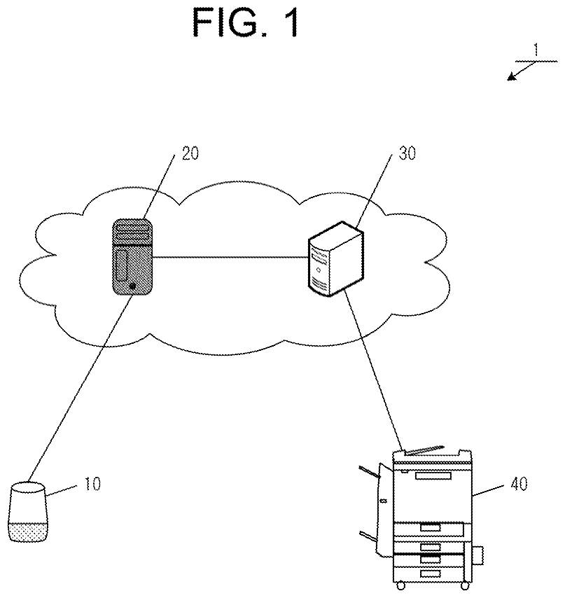

FIG. 1 is a schematic diagram of a print system 1 including a dialogue server 30 which is an information processor according to the present disclosure. Here, processor is a concept that includes device. For example, an information processor may include an information device such as computer. The print system 1 includes a voice inputter/outputter 10, a voice recognition server 20, the dialogue server 30, and an image former 40.

In the print system 1, the voice inputter/outputter 10 and the voice recognition server 20, the voice recognition server 20 and the dialogue server 30, and the dialogue server 30 and the image former 40 are respectively connected by a network such as the Internet. The devices may be connected by a network other than the Internet as long as the devices can exchange information with each other.

The voice inputter/outputter 10 is a device that inputs a voice (voicing content) voiced by a user and sends the voice as a voice signal (e.g., voice data or voice stream) to the voice recognition server 20, or outputs the voice which is based on the voice signal received from the voice recognition server 20. The voice inputter/outputter 10 includes, for example, a smart speaker and the like.

The voice recognition server 20 is an information processor (e.g., a server device) that recognizes a voice, which is based on voice signals, and sends the recognition result to a predetermined device.

The dialogue server 30 is an information processor (e.g., a server device) that provides a dialogue service. The dialogue service is a service that provides a user with predetermined information by realizing a dialogue with the user. In the present embodiment, the dialogue server 30 causes the voice inputter/outputter 10 to output, by voice, information of the image former 40, and thereby provides the user with the information of the image former 40.

The image former 40 is a digital multifunction machine that realizes a copy function, a printing function, a scanner function, a facsimile sending/receiving function, and the like.

1.2 Functional Configuration

1.2.1 Voice Inputter/Outputter

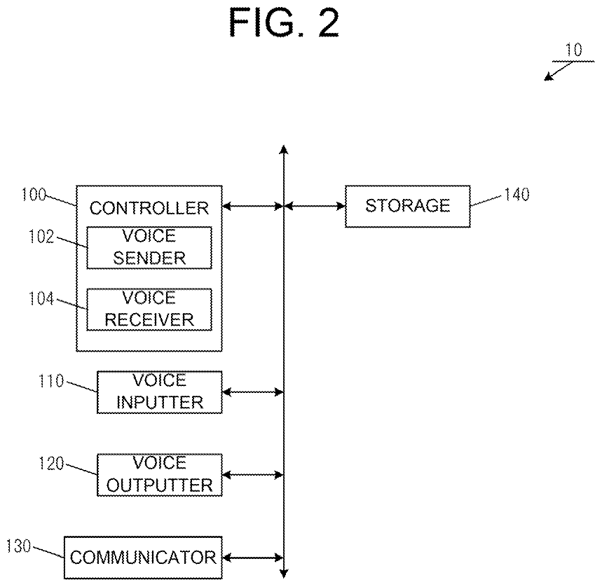

The functional configuration of the voice inputter/outputter 10 will be explained with reference to FIG. 2. As shown in FIG. 2, the voice inputter/outputter 10 has a controller 100, a voice inputter 110, a voice outputter 120, a communicator 130, and a storage 140.

The controller 100 controls the entire voice inputter/outputter 10. The controller 100, reads and executes various programs thereby to realize various functions, and includes, for example, one or more arithmetic devices (CPUs (Central Processors)) and the like.

The voice inputter 110 is a functional portion that converts a voice input by the user into a voice signal and outputs the voice signal to the controller 100. The voice inputter 110 includes a voice input device such as a microphone. The voice outputter 120 is a functional portion that outputs the voice which is based on the voice signal. The voice outputter 120 includes a voice output device such as a speaker.

The communicator 130 causes the voice inputter/outputter 10 to communicate with an external device such as the voice recognition server 20. For example, the communicator 130 includes an NIC (Network Interface Card) used in a wireless LAN, and a communication module (communication device) connectable to LTE (Long Term Evolution)/LTE-A (LTE-Advanced)/LAA (License-Assisted Access using LTE)/5G line.

The storage 140 stores various programs and various data necessary for the operation of the voice inputter/outputter 10. The storage 140 includes, for example, a storage device such as an SSD (Solid State Drive) which is a semiconductor memory, and an HDD (Hard Disk Drive).

In the present embodiment, the controller 100 reads and executes a program stored in the storage 140, and thereby functions as a voice sender 102 and a voice receiver 104.

The voice sender 102 converts into the voice signal output from the voice inputter 110 and sends the voice signal to the voice recognition server 20. From the voice outputter 120, the voice receiver 104 outputs the voice which is based on the voice signal received from the voice recognition server 20.

1.2.2 Voice Recognition Server

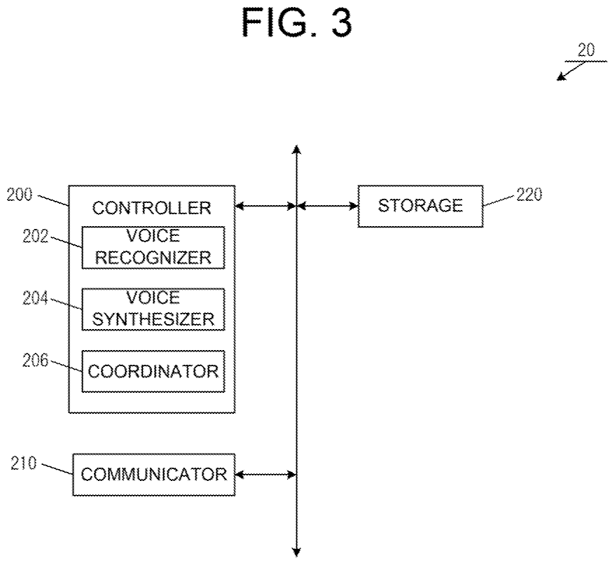

The functional configuration of the voice recognition server 20 will be explained with reference to FIG. 3. As shown in FIG. 3, the voice recognition server 20 has a controller 200, a communicator 210, and a storage 220.

The controller 200 controls the entire voice recognition server 20. The controller 200 reads and executes various programs thereby to realize various functions, and includes, for example, one or more arithmetic devices (CPUs) and the like.

The controller 200 reads and executes a program stored in the storage 220, and thereby functions as a voice recognizer 202, a voice synthesizer 204, and a coordinator 206.

The voice recognizer 202 recognizes a voice which is based on the voice signal received from an external device (e.g., the voice inputter/outputter 10). The voice synthesizer 204 executes voice synthesis based on text data received from an external device (e.g., the dialogue server 30). In the present embodiment, the text data that is the target of voice synthesis is referred to as voicing text data.

The coordinator 206 coordinates a device which sends the voice signal (e.g., the voice inputter/outputter 10), with a device which provides a dialogue service (e.g., the dialogue server 30).

For example, when the voice signal received from the voice inputter/outputter 10 is recognized by the voice recognizer 202, the coordinator 206, based on the recognition result, sends the recognition result to a predetermined server connected to the voice recognition server 20. The recognition result is, for example, text data (character string) indicating the voice (voicing content) voiced by the user. If the recognition result by the voice recognizer 202 includes a character string indicating a request for use of a dialogue service provided by the dialogue server 30, the coordinator 206 sends, to the dialogue server 30, information that requests use of the dialogue service. In the present embodiment, a voice (voicing content) input by the user to request the use of the service provided by a predetermined server is referred to as a wake word. Entering the wake word, the user can use the desired dialogue service.

In the case where the voice synthesis based on the voicing text data received from the server that is the destination of the recognition result is executed by the voice synthesizer 204, the coordinator 206 converts the voice, (synthesized voice) which is the result of the voice synthesis, into a voice signal, and sends the voice signal to the voice inputter/outputter 10. Further, when the voice signal is received again from the voice inputter/outputter 10 that has become the destination of the synthesized voice, the coordinator 206 sends again, to the same server, the recognition result which is based on the voice signal. In this way, the coordinator 206 realizes a continuous dialogue between the user and the server.

The communicator 210 causes the voice recognition server 20 to communicate with external devices such as the voice inputter/outputter 10 and the dialogue server 30. The communicator 210 includes, for example, a communication module (communication device) such as an NIC (Network Interface Card) that has an interface connectable to a network and can communicate with other devices via a wired/wireless LAN (Local Area Network).

The storage 220 stores various programs and various data necessary for the operation of the voice recognition server 20. The storage 220 includes, for example, a storage device such as an SSD which is a semiconductor memory, and an HDD.

1.2.3 Dialogue Server

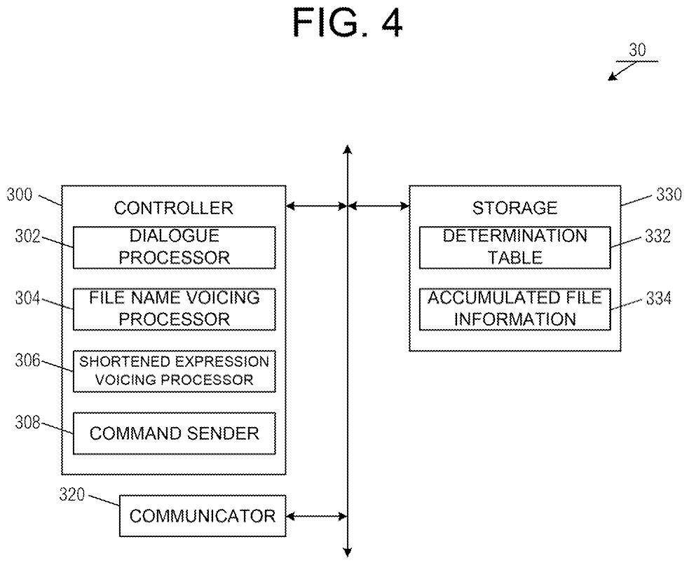

The functional configuration of the dialogue server 30 will be explained with reference to FIG. 4. As shown in FIG. 4, the dialogue server 30 has a controller 300, a communicator 320, and a storage 330.

The controller 300 controls the whole dialogue server 30. The controller 300 reads and executes various programs thereby to realize various functions, and includes, for example, one or more arithmetic devices (CPUs) and the like.

The controller 300 reads and executes a program stored in the storage 330 thereby to function as a dialogue processor 302, a file name voicing processor 304, a shortened expression voicing processor 306, and a command sender 308.

The dialogue processor 302 executes a voicing process that causes the voice inputter/outputter 10 to output (voice) a voice which is based on the voicing text data, and thereby executes a process for realizing the dialogue service. For example, the dialogue processor 302 receives, from the voice recognition server 20, a recognition result of the voice (voicing content) input by the user, and sends, to the voice recognition server 20, the voicing text data indicating the voicing content that is a response to the voicing content by the user.

The file name voicing processor 304 executes a voicing process that causes the voicing content, which includes a file name of a file that can be output by the image former 40, to be output (voice) from the voice inputter/outputter 10.

The shortened expression voicing processor 306 executes a voicing process that causes the voicing content, which includes a shortened expression of a file name of a file that can be output by the image former 40, to be output (voice) from the voice inputter/outputter 10. In the present embodiment, the shortened expression refers to an expression in which a part of the file name is omitted.

The command sender 308 sends a command to the image former 40. A command refers to an instruction and/or a request sent to the image former 40 in order to cause the image former 40 to execute a predetermined process.

The communicator 320 is a functional portion for the dialogue server 30 to communicate with external devices such as the voice recognition server 20 and the image former 40. The communicator 320 includes, for example, a communication module (communication device) such as an NIC used in a wired/wireless LAN.

The storage 330 stores various programs and various data necessary for the operation of the dialogue server 30. The storage 330 includes, for example, a storage device such as an SSD which is a semiconductor memory, or an HDD.

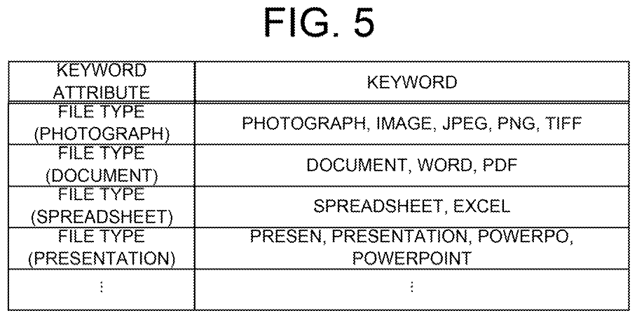

A determination table 332 and accumulated file information 334 are stored in the storage 330. As shown in FIG. 5, the determination table 332 stores a keyword attribute (e.g., “file type (photo)”) and a keyword (e.g., “photograph, image, JPEG, PNG, TIFF”) in correspondence.

Here, the file type indicates the format of the file. In the present embodiment, the file type is described as being any of “photograph”, “document”, “spreadsheet”, and “presentation (present)”. Note that “photograph” indicates that the file format is an image. For this reason, the file type may be described as “image” instead of “photograph”. Thus, the expression of the file type may be determined by the administrator or the like of the dialogue server 30 in accordance with the usage conditions, specifications, capabilities, and the like of the image former 40. If there should be any other file type that can be output by the image former 40, a keyword corresponding to a type other than the file types described above may be stored. In addition, only a keyword corresponding to a part of the file types described above may be stored.

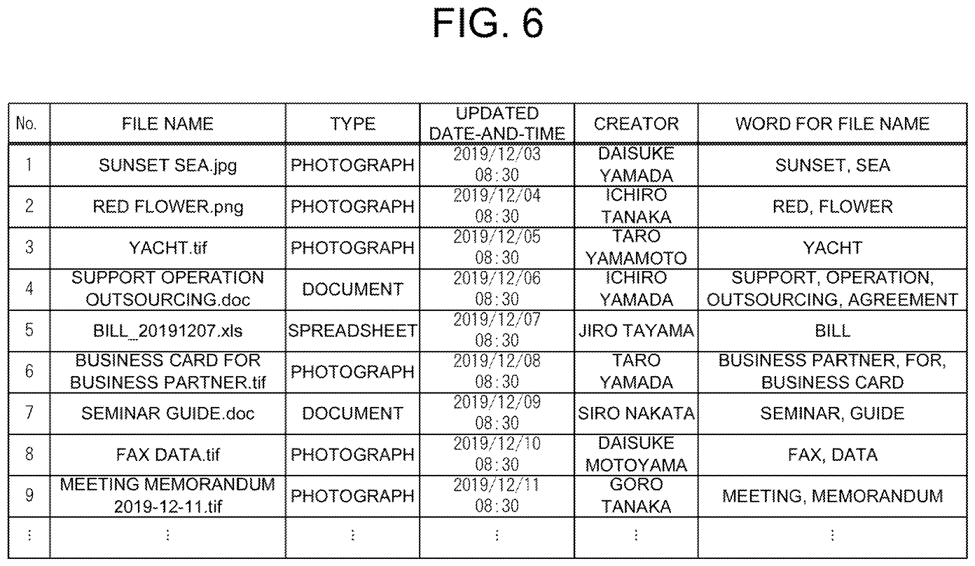

The accumulated file information 334 is a table that includes information about accumulated files which are files that can be output by the image former 40. As shown in FIG. 6, for example, the accumulated file information 334 stores, in correspondence, a serial number (No.), a file name (e.g., “sunset sea.jpg”), a file type (e.g., “photograph”), an updated date-and-time of the file (e.g., “2019/12/03 8:30”), a creator of the file (e.g., “Daisuke Yamada”), and a word (e.g., “sunset” or “sea”) included in the file name of the file.

An accumulated file is a file that is acquired by the image former 40. The accumulated file is, for example, stored (accumulated, stored) in a storage 460 of the image former 40 described below, or stored (accumulated, stored) in a device to which the image former 40 is connectable (e.g., NAS (Network Attached Storage)) or an external storage service.

1.2.4 Image Former

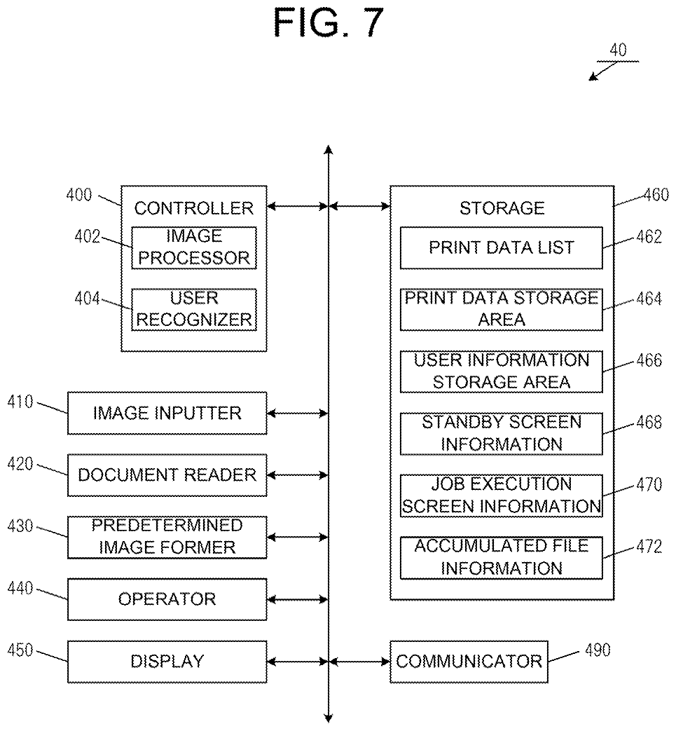

A functional configuration of the image former 40 will be explained with reference to FIG. 7. As shown in FIG. 7, the image former 40 has a controller 400, an image inputter 410, a document reader 420, a predetermined image former 430, an operator 440, a display 450, the storage 460, and a communicator 490.

The controller 400 is a functional portion for controlling the whole of the image former 40. The controller 400 reads and executes various programs thereby to realize various functions, and includes, for example, one or more arithmetic devices (CPUs) and the like.

The controller 400 reads and executes a program stored in a storage 460 thereby to function as an image processor 402 and a user authenticator 404.

The image processor 402 executes various image processes, such as sharpening process and color converting process, on the image data input and read by the image inputter 410 and the document reader 420. The image processor 402 converts the image data into print data which is image data that can be output by the predetermined image former 430, and stores the print data in a print data storage area 464.

The user authenticator 404 authenticates a user who uses the image former 40. For example, based on the user name and the password input from the operator 440, the user authenticator 404 determines whether the user is permitted to use the image former 40. For example, the user authenticator 404 executes a user authentication depending on whether or not the user name and password stored as information about the user (user information) stored in a user information storage area 466 match the user name and password inputted by the user. The user authentication may be based on biometric information of the user (e.g., fingerprint authentication, palm print authentication, face authentication, voice authentication, iris authentication, and the like), may be a method using an authentication server, and may be realized by using a known method.

The image inputter 410 inputs image data to the image former 40. The image inputter 410 may input image data stored in a storage medium such as a USB (Universal Serial Bus) memory, and an SD card, or may input image data acquired from another terminal device via the communicator 490.

The document reader 420 reads an image and generates image data. The document reader 420 includes, for example, a scanner device or the like that converts an image into an electrical signal by an image sensor such as a CCD (Charge Coupled Device) and a CIS (Contact Image Sensor), and quantizes and encodes the electrical signal thereby to generate digital data.

On a recording medium (e.g., recording paper), the predetermined image former 430 forms an image which is based on the print data. The predetermined image former 430 includes, for example, a laser printer or the like using an electrophotographic method.

The operator 440 receives an operation instruction by the user. The operator 440 includes, for example, a hard key (e.g., numeric keypad), a button, and the like. The display 450 displays various information to the user. The display 450 includes, for example, a display device such as an LCD (Liquid crystal display). The image former 40 may be provided with a touch screen in which the operator 440 and the display 450 are integrally formed. The method of detecting input may be any general detection method, for example, a resistive film method, an infrared method, an electromagnetic induction method, or a capacitance method.

The storage 460 stores various programs and various data necessary for the operation of the image former 40. The storage 460 includes, for example, a storage device such as an SSD which is a semiconductor memory, or an HDD.

The storage 460 stores a print data list 462, standby screen information 468, job execution screen information 470, and accumulated file information 472. Further, as storage areas, the print data storage area 464 as an area for storing print data, and the user information storage area 466 which is an area for storing user information are secured in the storage 460.

The print data list 462 is a list (queue) in which information identifying the print data (e.g., the name of the print data) is arranged in an order to be processed by the predetermined image former 430.

The standby screen information 468 is information used for displaying the standby screen, such as text and image to be displayed on the standby screen and information on the layout of the above text and image. The standby screen is a screen that includes a menu for receiving touch operations from the user (basic menu for touch operation). The job execution screen information 470 is information for displaying a voice operation dedicated screen, and is information about the text, image, and layout included in the voice operation dedicated screen. The voice operation dedicated screen is a screen that can accept a voice operation which is an operation based on a voice, and can execute a predetermined job based on the voice operation.

The accumulated file information 472 is a table including information about files that can be output by the image former 40, and is a table of the same format as the accumulated file information 334.

The communicator 490 is a functional portion for the image former 40 to communicate with an external device such as the dialogue server 30. The communicator 490 includes, for example, a communication module (communication device) such as an NIC used in a wired/wireless LAN.

1.3 Flow of Process

The main process flow of the present embodiment will be explained with reference to the drawing. The present embodiment describes a process for executing PULL print in which the image former 40 acquires a file preliminarily stored in a predetermined device or service and executes printing.

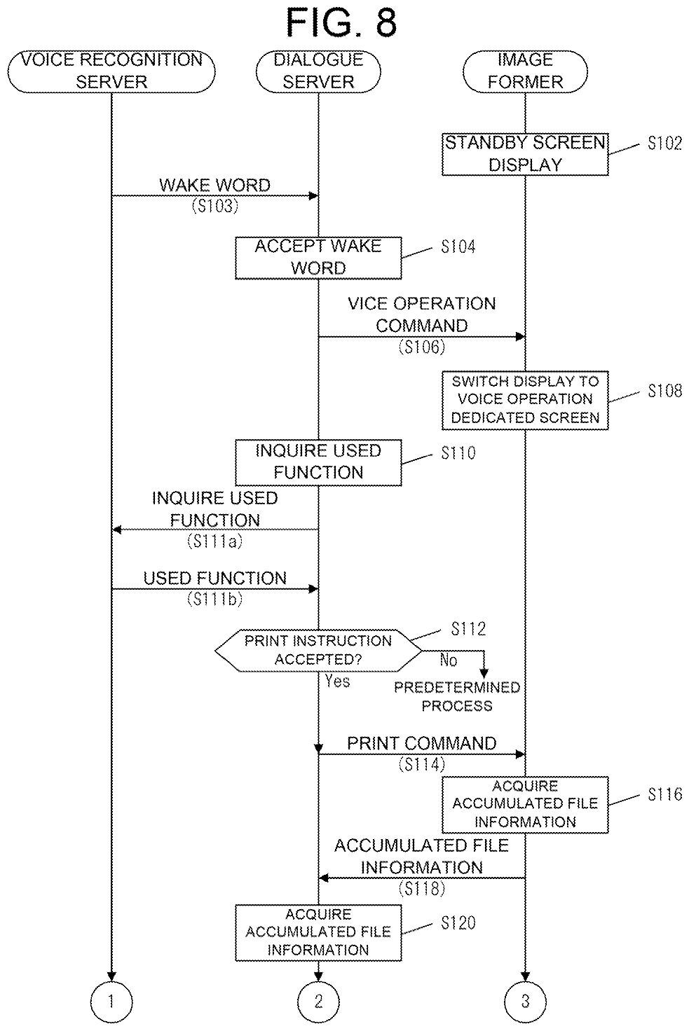

To begin, description will be made referring to FIG. 8. The controller 400 of the image former 40 reads the standby screen information 468 from the storage 460, and displays the standby screen on the display 450 (S102).

Next, the controller 200 of the voice recognition server 20 recognizes the voice signal received from the voice inputter/outputter 10, and if a wake word by the user's voice is input, the controller 200 sends, to the dialogue server 30, information indicating that the wake word has been input (S103).

Next, when receiving the information indicating that the wake word has been input from the voice recognition server 20, the controller 300 of the dialogue server 30 accepts the wake word (S104).

Next, to the image former 40, the controller 300 (command sender 308) of the dialogue server 30 sends a voice operation command indicating that the voice operation is to be executed (S106).

When receiving the voice operation command from the dialogue server 30, the controller 400 of the image former 40 switches, to the voice operation dedicated screen, the screen displayed on the display 450 (S108).

Next, the controller 300 (dialogue processor 302) of the dialogue server 30 executes the voicing process to inquire which function of the functions executed by the image former 40 is to be used (S110). For example, the dialogue processor 302 sends, to the voice recognition server 20, voicing text data inquiring about the used function, such as “Yes, what would you like to do?”, “Copy function, scan function, and PULL print function. Which do you want?” (S111a). To the voice inputter/outputter 10, the controller 200 of the voice recognition server 20 sends the voice signal of the synthesized voice which is based on the received voicing text data.

Next, to the dialogue server 30, the controller 200 sends the recognition result of the voice signal received from the voice inputter/outputter 10 (S111b). Here, it is assumed that the recognition result includes information about the used function. The controller 300 receives, from the voice recognition server 20, the recognition result of the voice (voicing content) input by the user, and determines whether or not to accept, from the user, a print instruction indicating use of the PULL print function (S112). For example, when the recognition result includes a character string (e.g., “I want to print”) indicating that PULL print is to be executed, the controller 300 accepts the print instruction.

When the print instruction is not accepted, the controller 300 executes a predetermined process based on the recognition result (S112; No). On the other hand, when the print instruction is accepted, the controller 300 (command sender 308) sends, to the image former 40, a print command indicating that the use of the PULL print function has been instructed (S112; Yes→S114).

When receiving the print command from the dialogue server 30, the controller 400 of the image former 40 acquires the accumulated file information (S116). For example, the controller 400 acquires or refers to the accumulated file, and generates accumulated file information based on the information (file name, format, and attributes of the file) of the above acquired accumulated file, thereby to acquire the accumulated file information. For example, the controller 400 extracts a word, whose word class is a noun, from the result of a morphological analysis of the file name, and designates the extracted word as a file name word. In the storage 460, the controller 400 stores the acquired accumulated file information as the accumulated file information 472.

In the case where the accumulated file information is generated by a device other than the image former 40 (e.g., a device or a service that stores the accumulated file), the controller 400 may acquire the generated accumulated file information.

Then, to the dialogue server 30, the controller 400 sends the accumulated file information acquired in S116 (S118). The controller 300 of the dialogue server 30 receives the accumulated file information from the image former 40 thereby to acquire the accumulated file information (S120). In the storage 340, the controller 300 stores the acquired accumulated file information as the accumulated file information 334.

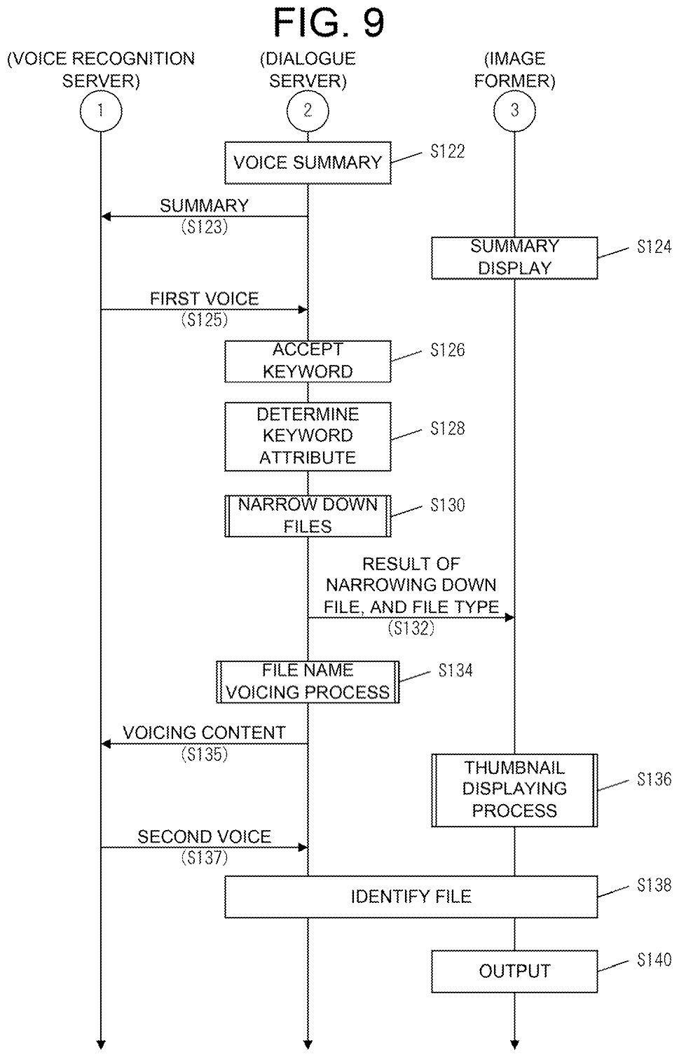

Next, description will be made referring to FIG. 9. The controller 300 (dialogue processor 302) of the dialogue server 30 executes a voicing process for voicing a summary which is based on the accumulated file information 334 (S122). The summary is the number of files seen in the case where the accumulated (stored) files are summarized per file type. To the voice recognition server 20, the controller 300 (dialogue processor 302) sends voicing text data indicating the summary, for example, “3 photographs, 2 documents, and 4 spreadsheets” (S123). To the voice inputter/outputter 10, the controller 200 of the voice recognition server 20 sends the voice signal of the synthesized voice which is based on the summary as the received voicing text data. Other than the summary, the controller 300 (dialogue processor 302) may include, in the voicing text data, the total number of accumulated (stored) files and a content to prompt to select a file, and may send the thus obtained to the voice recognition server 20.

The controller 400 of the image former 40 reads the accumulated file information 472 from the storage 340, and displays the summary on the display 450 (S124). For example, the controller 400 displays an option that summarizes, per file type, the number of accumulated (stored) files. The voicing content and display content based on the summary change based on the storage status of the file.

Next, to the dialogue server 30, the controller 200 of the voice recognition server 20 sends the recognition result of the voice signal received from the voice inputter/outputter 10 (S125). Here, it is assumed that the recognition result includes a first voice as a response to the summary. The controller 300 of the dialogue server 30 receives the keyword by the user's voice (first voice) thereby to acquire the keyword (S126). For example, when the recognition result received from the voice recognition server 20 matches any of the character strings stored as keywords in the determination table 332, the controller 300 accepts the keyword.

Then, the controller 300 determines the attribute of the accepted keyword (S128), determines, based on the determined keyword attribute, the file type voiced by the user, and executes a file narrowing down process which is based on the file type (S130). That is, the controller 300 treats the keyword as a narrow-down word to narrow down the file. The file narrowing down process refers to a process to narrow down, based on the keyword, files to be presented to the user, among accumulated files, and to determine an order of files to be presented to the user.

For example, based on the keyword attribute determined in S128, the controller 300 determines the file type voiced by the user. Specifically, when the keyword accepted in the case where the determination table 332 shown in FIG. 5 is stored is “word”, the keyword attribute corresponding to the keyword “word” is “file type (document)”. For this reason, the controller 300 determines “document” as the file type voiced by the user.

In addition, from the file names included in the accumulated file information 334, the controller 300 narrows down the files names that include the extension which corresponds to the file type voiced by the user. The extension corresponding to the file type should be preliminarily stored in the storage 330. The file name may be narrowed down based on the type of information stored in the accumulated file information 334.

Further, the controller 300 rearranges the narrowed down file names in a predetermined order. The file names may be rearranged, for example, in the order of file names, in the descending or ascending order of creation date-and-time or updated date-and-time, in the order of frequency of use, or in the order based on serial numbers. In this way, as a result of the file narrowing down process, the controller 300 acquires (generates) the information on the files arranged in the order to be presented to the user. The result of the file narrowing down process is, for example, a list of file names (character strings).

To the image former 40, the controller 300 sends the result of the file narrowing down process and the file type (keyword attribute) voiced by the user (S132). In this way, the controller 300 causes the image former 40 to switch the display mode of the files narrowed down based on the keyword.

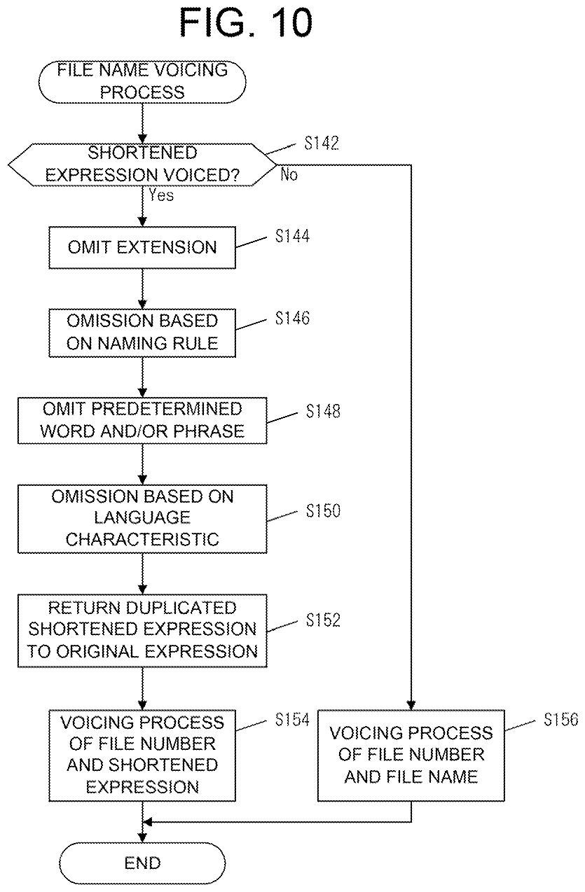

Next, the controller 300 of the dialogue server 30 executes a process of voicing the file name (file name voicing process), based on the result of the file narrowing down process received from the dialogue server 30 (S134). The file name voicing process will be explained with reference to FIG. 10.

At first, the controller 300 determines whether or not to voice the shortened expression (step S142). The controller 300 determines, for example, that the shortened expression is to be voiced in any of the following cases.

(1) When the user specifies that the shortened expression is to be voiced

(2) When the number of narrowed down files exceeds a predetermined threshold value

(3) When exceeding the predetermined time in the case of voicing the file name of the narrowed down file

The threshold value in the case of (2) may be set by the user or by the dialogue server 30. In a thumbnail displaying process described below, when the thumbnail images for all the files narrowed down on the display 450 fail to be displayed at once, the controller 300 may determine that the shortened expressions are to be voiced. (3) In the case of, it may be determined that the shortened expression is to be voiced when the time taken when the file name included in the narrowing result is voiced as it exceeds the predetermined time.

In the case of voicing the shortened expression (step S142; Yes), the controller 300 (shortened expression voicing processor 306) determines the to-be-voiced content based on the result of the file narrowing down process. In the present embodiment, the result of the file narrowing down process will be explained as a list of character strings of file names arranged in a predetermined order.

From each character string included in the list of character strings, the controller 300 (shortened expression voicing processor 306) omits (deletes) the character string which corresponds to an extension (step S144). For example, the controller 300 (shortened expression voicing processor 306) omits the extension “.jpg” from a character string such as “sunset sea.jpg” thereby to make a character string such as “sunset sea”.

Next, based on the file naming rule, the controller 300 (shortened expression voicing processor 306) omits (deletes) a predetermined character string from each character string included in the list of character strings (step S146). Specific examples are as follows.

(1) When a predetermined symbol (e.g., an underscore or a hyphen) and a character string indicating year/month/date or date-and-time appear at the top or the end of the character string, the controller 300 (shortened expression voicing processor 306) omits the predetermined symbol and the character string indicating the year/month/date and the date-and-time.

(2) When a character string (e.g., a serial number, a predetermined code, a hash value, and the like), which is information used by a predetermined device and has no meaning for a user, appears at a specific position of the character string, the controller 300 (shortened expression voicing processor 306) omits the character string.

(3) When a character string indicating the user's affiliation such as a company name, a department name or a department code appears at a specific position of the character string, the controller 300 (shortened expression voicing processor 306) omits the character string.

For example, the controller 300 (shortened expression voicing processor 306) omits the underscore and the year/month/date from a character string such as “quotation_191213” thereby to make the character string into a character string such as “quotation”.

A pattern (rule) of character strings to be omitted based on the file naming rule may be stored, for example, in the storage 330. When omitting the predetermined expression based on the file naming rule, the controller 300 (shortened expression voicing processor 306) reads a pattern (rule) stored in the storage 330, and applies the rule to each string included in the list of character strings. The character string patterns (rules) to be omitted based on the file naming rule may be predetermined, or may be settable by the user.

Next, from the respective character strings included in the list of character strings, the controller 300 (shortened expression voicing processor 306) omits (deletes) a predetermined word and/or phrase set to suppress voicing (step S148). The predetermined word and/or phrase is, for example, a word and/or phrase that cannot identify the content of a file, specifically, a word and/or phrase such as “file,” “data,” and “text.” The predetermined word and/or phrase may be predetermined, or may be settable by the user. In S148, the controller 300 (shortened expression voicing processor 306) makes a character string such as “fax data” into a character string such as “fax”, for example.

Next, based on the feature of the language, the controller 300 (shortened expression voicing processor 306) omits (deletes) a predetermined character string from the respective character strings included in the list of character strings (step S150). Specific examples (patterns) are as follows.

(1) Omit a word of word class other than a noun.

(2) If the character string is Japanese, the prefix is omitted.

(3) If the character string includes the word “of” in English, omit the word “of” and beyond.

For example, the controller 300 (shortened expression voicing processor 306) omits the prefix “go” from a Japanese character string such as “go-annaizu (guide map)” thereby to make a character string such as “annaizu (guide map)”. In addition, from the English character strings such as “notice of . . . ”, “document of . . . ”, and “report of . . . ”, the controller 300 (shortened expression voicing processor 306) omits the description “of” and beyond thereby to make “notice”, “document” and “report”, respectively.

The above-mentioned patterns of character strings to be omitted based on the feature of the language are examples, and there may be patterns other than those described above. A plurality of patterns may be combined so that a predetermined string of characters may be omitted.

The controller 300 (shortened expression voicing processor 306) executes the processes of steps S144 to S150 thereby to omit the predetermined character string (expression) from the respective character strings included in the list of character strings thereby to acquire a shortened expression of the file name. The method of acquiring the shortened expressions is not limited to the method described above. For example, the controller 300 (shortened expression voicing processor 306) may omit a part of the processes described in steps S144 to S150, or may execute a processes other than those described in steps S144 to S150 thereby to acquire the shortened expression. Further, the controller 300 (shortened expression voicing processor 306) may execute only the process selected by the user, among the processes described in steps S144 to S150.

Next, when a duplicated shortened expression occurs to a character string (shortened expression) included in the list of character strings, the controller 300 (shortened expression voicing processor 306) returns the duplicated shortened expression to the file name of the original expression (step S152). This allows the controller 300 (shortened expression voicing processor 306) to ensure that each string included in the list of character strings does not duplicate in expression with any other string. Instead of returning to the file name in step S152, the controller 300 (shortened expression voicing processor 306) may return to the omitted expression up to the case where the file name is omitted to the extent that no duplication occurs.

Then, based on the list of character strings, the controller 300 (shortened expression voicing processor 306) executes the voicing process for voicing the shortened expression of a file name and a file number (step S154). The file number is the number given to the file to be presented to the user, and is specifically a sequential number starting from 1.

For example, the controller 300 (shortened expression voicing processor 306) reads the list of character strings one by one from the top, and gives a file number to each of the read character strings. Then, the controller 300 (shortened expression voicing processor 306) generates the voicing text data by concatenating the character strings to which the file numbers are given, and sends the voicing text data to the voice recognition server 20.

For example, when the list of character strings includes character strings such as “sunset sea”, “red flower”, and “yacht”, the controller 300 (shortened expression voicing processor 306) generates voicing text data such as “1 sunset sea, 2 red flower, and 3 yacht”. In the voicing text data, the controller 300 (shortened expression voicing processor 306) may include the number of narrowed down files and the content that prompts the selection of a file.

If it is determined in step S142 that the shortened expression is not to be voiced, the controller 300 (file name voicing processor 304), based on the character string (file name) included in the list of character strings, executes a voicing process for voicing the file number and the file name (step S142; No→step S156). For example, when the list of character strings includes character strings such as “sunset sea.jpg”, “red flower.png”, and “yacht.tif”, the controller 300 (file name voicing processor 304) generates voicing text data such as “1 sunset sea.jpg, 2 red flower.png, and 3 yacht.tif” and sends the voicing text data to the voice recognition server 20. In the voicing text data, the controller 300 (file name voicing processor 304) may include the number of narrowed down files and the content that prompts the selection of a file.

Returning to FIG. 9, the file name voicing process in S134 sends, from the dialogue server 30 to the voice recognition server 20, the voicing text data indicating the voicing content (S135). To the voice inputter/outputter 10, the controller 200 of the voice recognition server 20 sends the voice signal of the synthesized voice which is based on the received voicing text data.

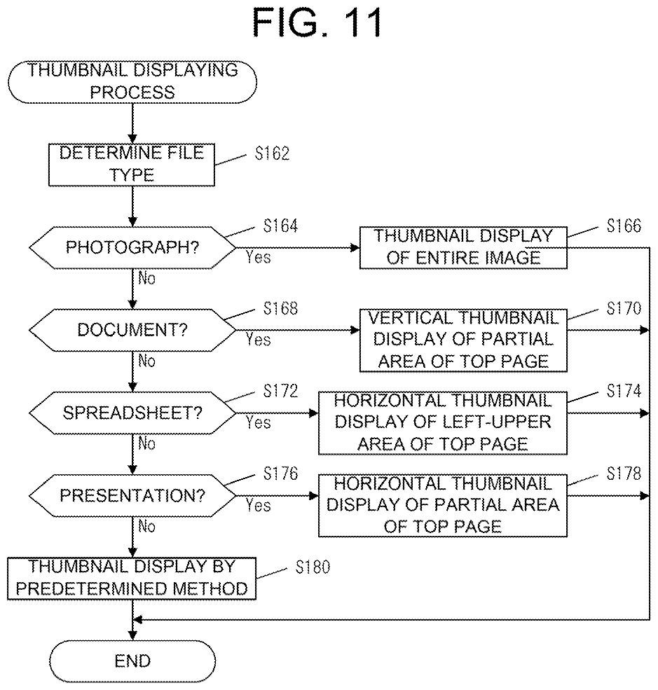

The controller 400 of the image former 40 executes the thumbnail displaying process that displays, on the display 450, thumbnail images of the files included in the file groups narrowed down by the file narrowing down process (S136). The thumbnail displaying process will be explained with reference to FIG. 11.

At first, the controller 400 determines the file type (file attribute) received in S132 (step S162). If the file type is a photograph, the controller 400 displays, on the display 450, a thumbnail image in which the entire image is reduced for each of the files included in the file group narrowed down by the file narrowing down process (step S164; Yes→step S166). For example, the controller 400 reads, one by one, the information of the files included in the result of the file narrowing down process, and acquires the file which corresponds to the information of the read file. The controller 400 reads the acquired file (image file) and displays, on the display 450, the thumbnail image which is based on the entire image indicated by the read file. In this way, the controller 400 displays each entire image as a thumbnail. The controller 400 gives the file number to each read file, and displays the file number superimposed on the thumbnail image, or displays the file number around the thumbnail image.

If the file type is a document, the controller 400 displays, on the display 450, for each file (document file) included in the file group, a vertical thumbnail image in which a partial area of the top page is enlarged (step S164; No→step S168; Yes→step S170).

If the file type is a spreadsheet, the controller 400 displays, on the display 450, for each file (spreadsheet file) included in the file group, a horizontal thumbnail image in which the upper left area of the top page is enlarged (step S168; No→step S172; Yes→step S174).

If the file type is presentation, the controller 400 displays, on the display 450, for each file (presentation file) included in the file group, a horizontal thumbnail image in which a partial area of the top page is enlarged (step S172; No→step S176; Yes→step S178).

That is, in steps S170, S174, and S178, the controller 400, in the same manner as in step S166, reads, one by one, the information of the files included in the result of the file narrowing down process, acquires the corresponding files, and displays the thumbnail image.

If a type other than the file types described above is accepted as a keyword and the files are narrowed down, the controller 400 executes a thumbnail display of the narrowed down file group by a predetermined method (step S176; No→step S180). Other than the thumbnail image, the controller 400 may display, on the display 450, the file name of the file which corresponds to the thumbnail image.

In executing the thumbnail display, the controller 400 may synchronize the thumbnail display with the file name voicing process executed by the dialogue server 30. For example, the controller 400 may display, in an enlarged manner, the thumbnail image of the file which corresponds to the file name being voiced by the dialogue server 30. In this case, when the next file name is voiced by the dialogue server 30, the controller 400 restores the enlarged display, and repeats the process of displaying, in an enlarged manner, the thumbnail image of the file which corresponds to the above next file name.

If the number of files is too large to fit the thumbnail images to a single screen, the controller 400 may scroll and display the screen in conjunction with the progress of the reading pronunciation of each file name by the dialogue server 30, and continue scrolling so that the file being voiced appears on the screen.

Even if the number of files is too large to fit the thumbnail images to the single screen, the controller 400 may scroll the screen based on the user's operation instead of scrolling the screen in conjunction with the progress of the reading pronunciation of each file name by the dialogue server 30.

Although it has been explained that the dialogue server 30 sends the file type (keyword attribute) to the image former 40 in S132, the dialogue server 30 may send, to the image former 40, the information indicating the display mode, instead of sending the information indicating the file type. For example, if the keyword attribute determined in S128 is “file type (photograph),” the controller 300 of the dialogue server 30 sends, in S132, information for reducing and displaying the entire image of each file which is based on the result of the file narrowing down process. If the keyword attribute determined in S128 is “file type (document),” the controller 300 of the dialogue server 30 sends, in S132, information for vertically displaying, as a thumbnail, a partial area of the top page of each file which is based on the result of the file narrowing down process. Similarly, when the keyword attribute is “file type (spreadsheet)” or “file type (presentation)”, the controller 300 of the dialogue server 30 sends, to the image former 40, information on the display mode of the file which is based on the result of the file narrowing down process. The controller 400 of the image former 40 displays thumbnail of the file based on the information indicating the display mode received from the dialogue server 30. In this way, the dialogue server 30 can control the image former 40 to switch to the display mode which corresponds to the keyword attribute.

Then, returning to FIG. 9, the controller 200 of the voice recognition server 20 sends, to the dialogue server 30, the recognition result of the voice signal received from the voice inputter/outputter 10 (S137). Here, it is assumed that a second voice, which is a response to the voicing process based on the file name voicing process, is included. Next, the dialogue server 30 and the image former 40 identify a file based on the second voice (S138). The dialogue server 30 and the image former 40 may identify the file based on the user's operation, instead of the second voice. The process of identifying the file in S138 is executed, for example, by the following method.

(1) Method Based on User's Voicing (Second Voice)

When receiving, from the voice recognition server 20, the recognition result indicating the second voice, the controller 300 of the dialogue server 30 determines whether or not the recognition result includes the file number. If the file number is included, the controller 300 identifies the file which corresponds to the file number, and sends, to the image former 40, information (e.g., file name) of the identified file. If the file number is not included, the controller 300 determines whether or not the content of the user's voicing content indicated as the recognition result is included in the file name of any of the files indicated by the result of the process in S130. When one file including the content of the user's voicing content is identified, the controller 300 sends, to the image former 40, the information (e.g., file name) of the identified file.

If there is no file including the user's voicing content or there is a plurality of files including the user's voicing content, the controller 300 (dialogue processor 302) executes a voicing process so as to execute voicing to prompt the user to input the voice again.

(2) Method Based on Touch Operation

When the thumbnail image displayed on the display 450 is selected by a touch operation, the controller 400 of the image former 40 identifies the above selected file.

Then, via the predetermined image former 430, the controller 400 of the image former 40 forms an image which is based on the file identified in S138, thereby to execute outputting (printing) (S140). Before the printing is executed, the controller 400 may display, on the display 450, the thumbnail image of the identified file in a close-up and enlarged view. In addition, when the identified file includes a plurality of pages, the controller 400 may expand the plurality of pages and continuously display the plurality of pages on the display 450. In this way, the controller 400 can allow the user to confirm whether or not the identified file is correct. In this case, the controller 400 executes printing after the user has confirmed that the file has been correctly identified.

1.4 Operation Example

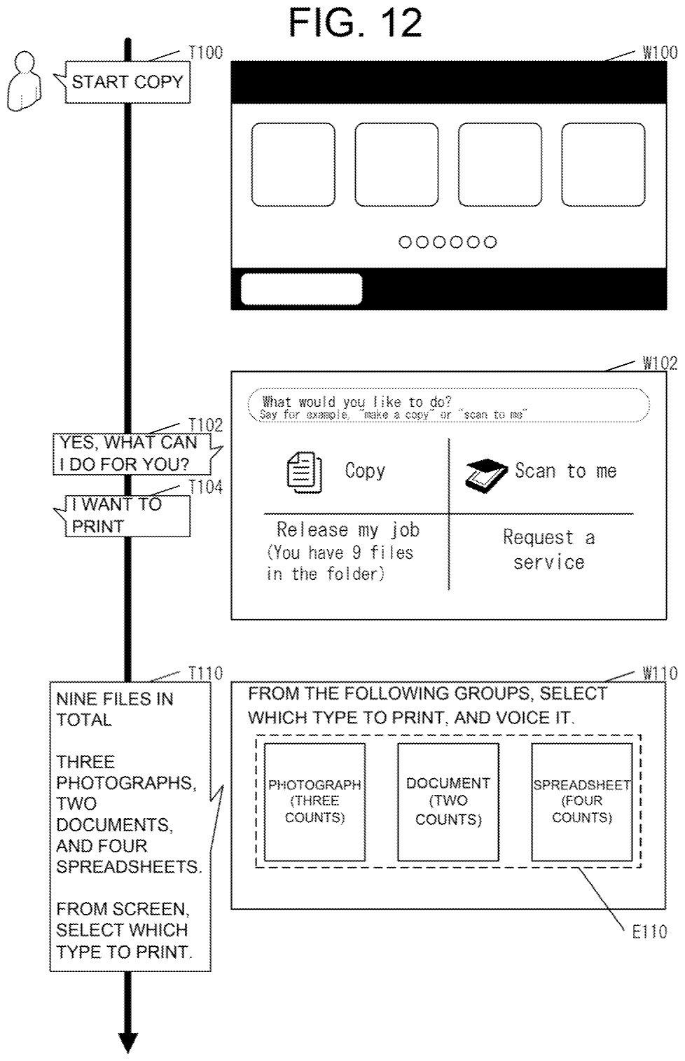

An operation example of the present embodiment will be explained with reference to the drawing. First, referring to FIG. 12, the process of presenting the summary to the user will be described. When a wake word T100, such as “Start copy”, is voiced by the user when a standby screen W100 is displayed on the display 450, the screen displayed on the display 450 switches to a voice operation dedicated screen W102. At this time, the voice inputter/outputter 10 outputs a voice T102, such as “Yes, what can I do for you?”, which inquires the user about the function to be used.

When a print instruction T104 such as “Make a print” is voiced by the user, a screen W110 including an area E110 with the summary is displayed on the display 450. In addition, the voice inputter/outputter 10 outputs a voice T110 indicating the summary. For example, in the example of FIG. 12, the area E110 of the screen W110 includes a display indicating that there are three photographs, two documents, and four spreadsheets, as the summary. In addition, as a voice T110, it is output that there are nine files in total, three photographs, two documents, and four spreadsheets, and that the user is prompted to select the file type.

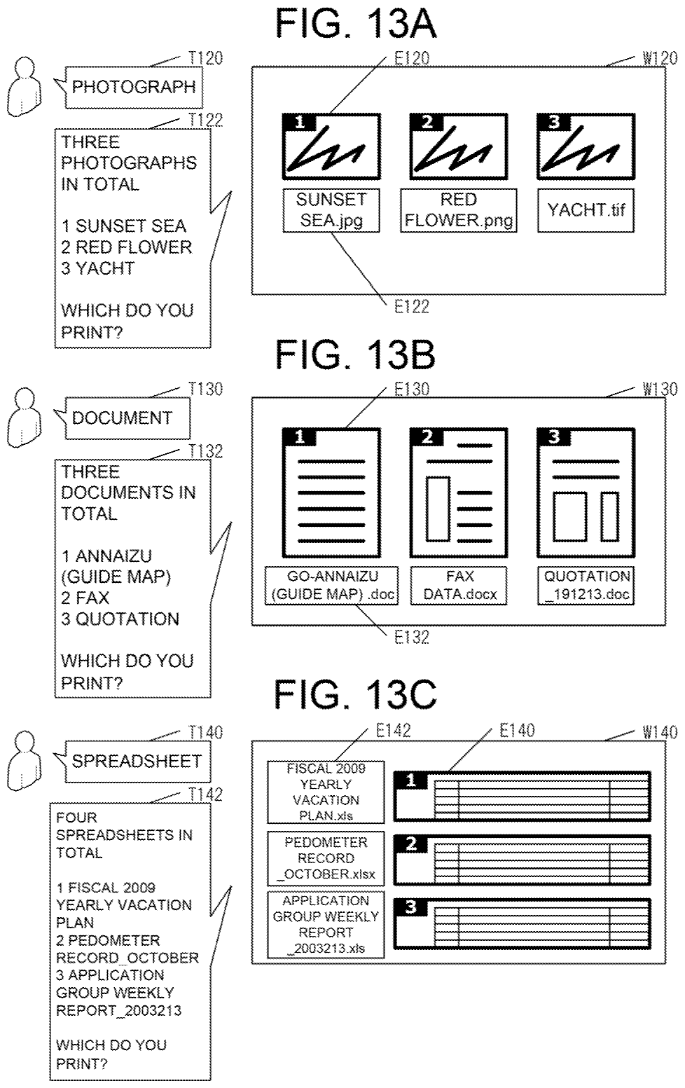

Next, referring to FIGS. 13A to 13C, the thumbnail display and the shortened expressions will be explained. FIG. 13A illustrates a case in which “photograph” is voiced by the user as a voice T120 indicating the file type. The display 450 shows a screen W120 for displaying the thumbnail. The screen W120 displays, for each file whose file type is “photograph,” a thumbnail image of the entire image indicated by the file (e.g., image E120) and the file name (e.g., area E122). In addition, the voice inputter/outputter 10 outputs a voice T122 including the shortened expression and the file number. In the voice T122, the shortened expression of the file name of the file whose file type is “photograph” is output. For example, a voice such as “sunset sea” is output as a shortened expression of a file whose file name is “sunset sea.jpg”.

FIG. 13B illustrates a case in which “document” is voiced by the user as a voice T130 indicating the file type. A screen W130 for displaying a thumbnail is displayed on the display 450, and a vertical thumbnail image (e.g., image E130) and a file name (e.g., area E132) are displayed for each of the files whose file type is “document,” with a partial area of the top page enlarged. The voice inputter/outputter 10 outputs a voice T132 including the shortened expression and the file number.

For example, as a shortened expression of a file whose file name is “go-annaizu (guide map.doc”, a voice such as “annaizu (guide map)” is output, with the extension and the prefix “go” omitted. As a shortened expression of a file whose file name is “fax-data.docx”, a voice such as “fax” is output, with the extension and the predetermined word “data” omitted. As a shortened expression of the file whose file name is “quotation_191213.doc”, a voice such as “quotation” is output, with the extension, underscore, and year/month/date omitted.

FIG. 13C illustrates a case in which “spreadsheet” is voiced by the user as a voice T140 indicating the file type. In the display 450, a screen W140 for displaying a thumbnail is displayed, and for each file whose file type is “spreadsheet”, a horizontal thumbnail image (e.g., image E140) and a file name (e.g., area E142) are displayed, in which the upper left area of the top page is enlarged. The voice inputter/outputter 10 outputs a voice T142 including the shortened expression and the file number. For example, as shown in FIG. 13C, an omitted expression in which only the extension is omitted as an omitted expression may be output.

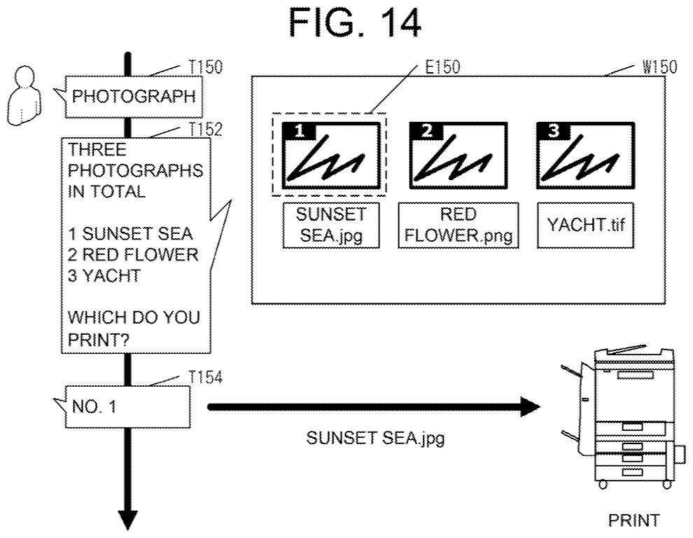

FIG. 14 shows an example of the file identification and output operation. A voice T150, a screen W150, and a summary voice T152 of FIG. 14 correspond to the voice T120, the screen W120, and the summary voice T122 of FIG. 13A, respectively. In this state, a file is identified when a voice or operation for identifying the file is input by the user. For example, when a file number (e.g., “No. 1”) is input as a voice T154 for identifying a file, information on the file corresponding to the file number (e.g., a file name of the file whose file number is No. 1) is sent from the dialogue server 30 to the image former 40. Instead of the user voicing the voice T154, a thumbnail (e.g., thumbnail E150) displayed on the screen W150 may be touched by the user, and the file corresponding to the touched thumbnail may be identified as the to-be-printed file. The image former 40, from the device in which the accumulated file is stored, acquires a file which corresponds to the information of the received file, and executes printing.

The voice T154 used to identify the file may be a part of the file name. In the present embodiment, the voice output from the voice inputter/outputter 10 is a voice that includes word and/or phrase that can uniquely identify a file. Therefore, the user needs to voice only the omitted expression which corresponds to the file for which the output is desired, among the voices output from the voice inputter/outputter 10. For example, in the example shown in FIG. 14, the user needs to only say “yacht”, and the file whose file name is “yacht.tif” is acquired and printed by the image former 40.

In the present embodiment, it has been described that the file narrowing down process is executed by the dialogue server 30, but it may be executed by the image former 40. In this case, the dialogue server 30 sends, to the image former 40, the recognition result of the voice (voicing content) inputted by the user. The image former 40 stores the determination table in the storage 460, executes the file narrowing down process based on the determination table, and sends the result of the narrowing down process to the dialogue server 30.

The file narrowing result may also include the file number. In this way, either the dialogue server 30 or the image former 40 needs to execute the process of giving the file number.

Although the voice inputter/outputter 10, the voice recognition server 20, the dialogue server 30, and the image former 40 have been described as separate devices, a plurality of or all of the respective devices may be realized as a single device. For example, by having a terminal device such as a smartphone execute a dedicated application, the terminal device may be caused to execute a process executed by the voice inputter/outputter 10 and the voice recognition server 20, and may also be caused to execute a process executed by the dialogue server 30. In addition, the image former 40 may execute the process executed by the dialogue server 30. In this case, the image former 40 can acquire a keyword based on the recognition result sent from the voice recognition server 20, narrow down the file based on the keyword, and output (print) the file. In addition, the image former 40 may execute the process executed by the voice inputter/outputter 10, the voice recognition server 20, and the dialogue server 30. In this case, the image former 40 can execute from the voice recognition to the file output by itself.

According to the present embodiment, the user can narrow down the files from a plurality of stored files based on the voice dialogue, can voice the file number or a part of the file name of the narrowed down file, and thereby can specify a file. In this way, when specifying the file, it is not necessary to read out all the file names, therefore, which can save the user the time and effort of specifying the file, or which makes it possible to take an action in the case of specifying a file that is difficult to read.

In addition, if the file type narrowed down based on the user's voice is a photograph, the image former of the present embodiment allows the user to easily grasp the content of each file by displaying a thumbnail of the entire area of each file, thereby enabling the user to easily identify the to-be-printed file. If the file type narrowed down based on the user's voice is a document or spreadsheet file, the image former of the present embodiment allows the user to easily grasp the content of each file by enlarging a partial area of each file and displaying thumbnails, thereby enabling the user to easily identify the to-be-printed file.

### 2. Second Embodiment

Next, a second embodiment will be explained. The second embodiment is an embodiment in which it is possible to narrow down the file by the information (attribute) given to the file, in addition to the file type.

2.1 Functional Configuration

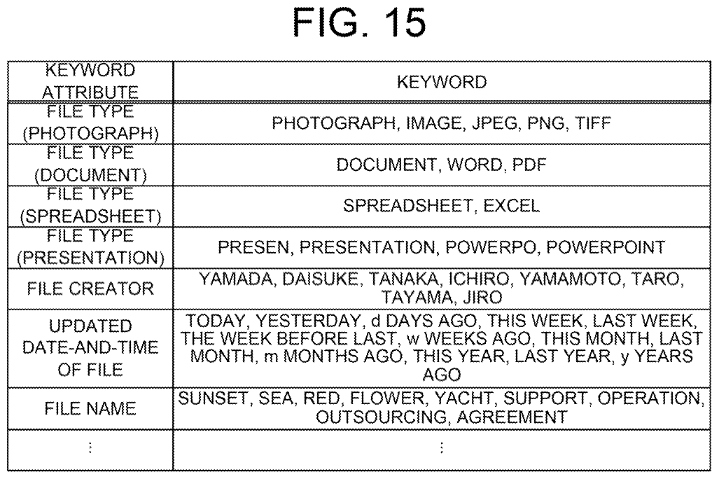

An example of a determination table 332 in the present embodiment is shown in FIG. 15. In addition to the determination table 332 shown in FIG. 4 of the first embodiment, the determination table 332 in the present embodiment stores keywords whose attributes are the creator, date-and-time, and the file name.

The keyword whose attribute is the creator of the file is a keyword in the case of narrowing down the files which are based on the creator of the file, among the attributes of the file, and specifically, it is the given name or surname of the creator. The keyword whose attribute is the updated date-and-time of the file is a keyword in the case of narrowing down the files based on the updated date-and-time of the file, among the attributes of the file. Any keyword whose attribute is the updated date-and-time of the file is a specific word such as “today” or “yesterday”, or a word indicating a specific date-and-time or period such as “d days ago”, “m months ago”, or “y years ago”. The “d”, “m”, and “y” included in the keyword indicating the specific date-and-time or period are arbitrary numerical values, and words such as “three days ago”, “two months ago”, and “one year ago” are used as the keyword. The keyword whose attribute is the file name is a keyword in the case of narrowing down the files which are based on the word included in the file name.

2.2 Flow of Processes

The main process flow in the present embodiment will be explained below. In the present embodiment, the dialogue server 30 and the image former 40 first execute the process shown in FIG. 8 in the first embodiment.

After acquiring the accumulated file in S116 of FIG. 8, the controller 400 in the present embodiment stores the word, which is included in the file name, as a keyword whose keyword attribute is the file name. The controller 400 extracts a surname or a given name from the creator's information stored as an attribute of the acquired file, and stores the extracted surname or given name as a keyword whose keyword attribute is the creator.

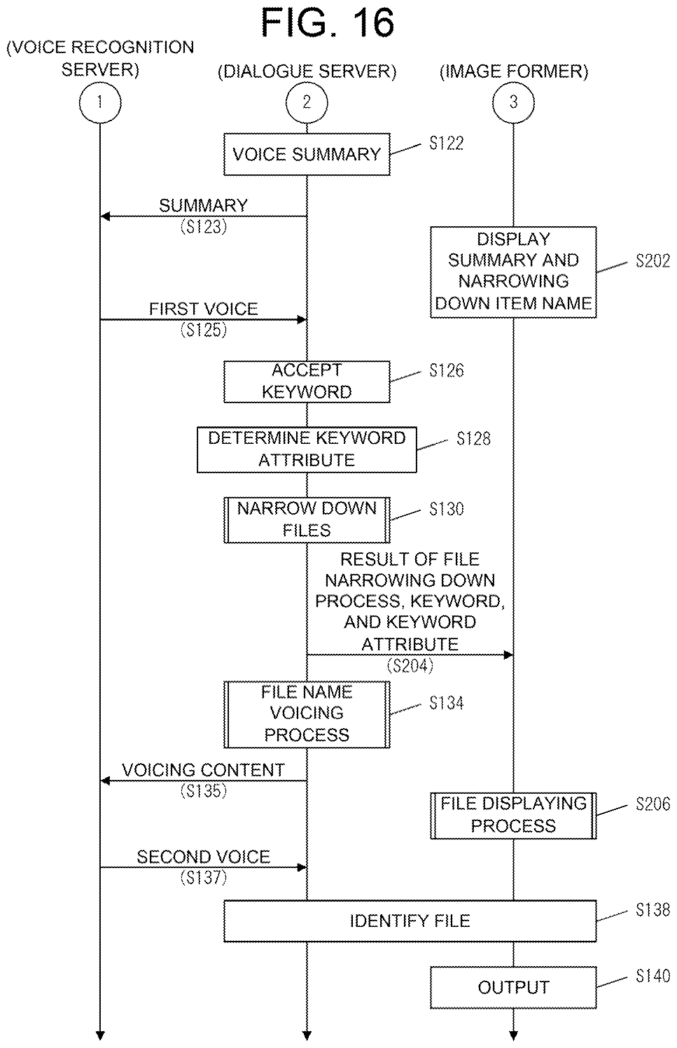

After executing the process shown in FIG. 8, the dialogue server 30 and the image former 40 further execute the process shown in FIG. 16. First, the controller 400 of the image former 40, after acquiring the accumulated file information in S116 of FIG. 8, displays the summary and a narrow-down item name on the display 450 (S202). The narrow-down item name identifies the information type (attribute) given to a file, and is used to narrow down the accumulated (stored) file.

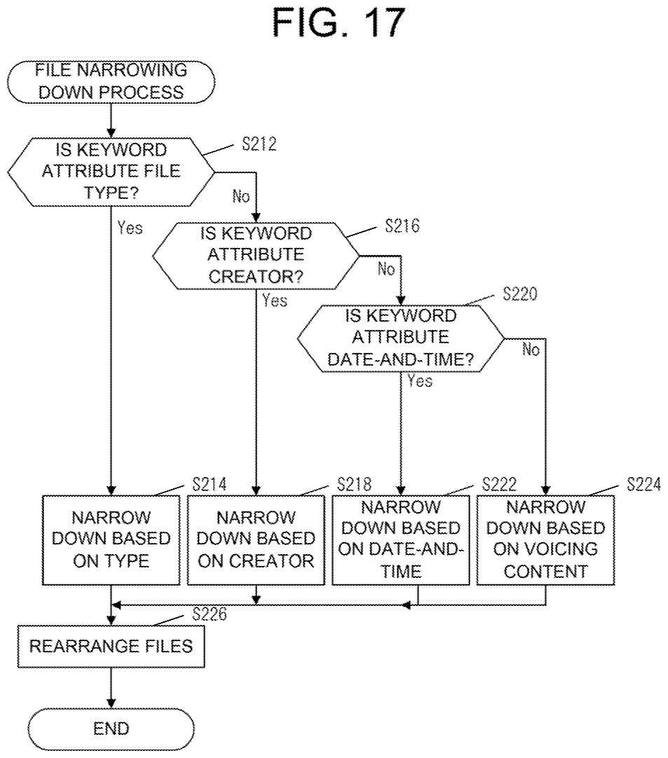

Further, the controller 300 executes the file narrowing down process (S130). The file narrowing down process in the present embodiment will be explained with reference to FIG. 17.

The controller 300 of the dialogue server 30 narrows down the files based on the keyword attribute. For example, if the keyword attribute determined in S128 is the file type, the controller 300 narrows down the accumulated (stored) files based on the file type (step S212; Yes→step S214).

When the keyword attribute is the creator of the file, the controller 300 narrows down the files based on the creator (keyword) voiced by the user (step S212; No→S216; Yes→step S218). Specifically, the controller 300 extracts, among the accumulated (stored) files, the file whose creator matches the creator (keyword) voiced by the user, and thereby narrows down the files.

When the keyword attribute is the date-and-time, the controller 300 narrows down the files based on the date-and-time (keyword) voiced by the user (step S216; No→step S220; Yes→step S222). Specifically, the controller 300 extracts, among the accumulated (stored) files, the file whose file updated date-and-time matches the date-and-time (keyword) voiced by the user, and thereby narrows down the files.

If the keyword attribute is not the date-and-time, the keyword attribute is the file name. In this case, the controller 300 narrows down the files, based on the name (keyword) voiced by the user (step S220; No→step S224). Specifically, the controller 300 narrows down the files by extracting, among the accumulated (stored) files, the file that includes the content (keyword) voiced by the user.

Then, the controller 300 rearranges the files narrowed down in step S214, step S218, step S222, and step S224 (step S226). Similar to the first embodiment, the files may be rearranged in a predetermined manner, such as in the order of file names, in the descending or ascending order of creation date-and-time or updated date-and-time, or in the order of frequency of use.

Returning to FIG. 16, the controller 300 of the dialogue server 30 sends, to the image former 40, the result of the file narrowing down process in S130, the keyword accepted (acquired) in S126, and the keyword attribute which corresponds to the keyword (S204).

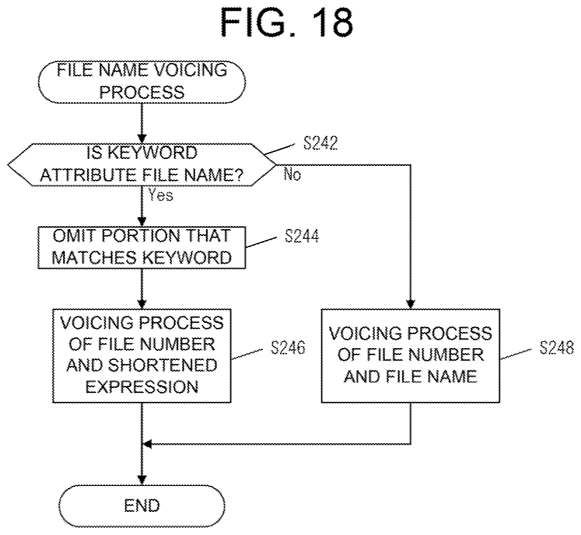

Further, the controller 300 executes the file name voicing process, based on the result of the file narrowing down process (S134). The file name voicing process in the present embodiment will be explained with reference to FIG. 18. In the present embodiment, the voicing process is switched according to the keyword attribute.

At first, the controller 300 determines whether or not the keyword attribute determined in S128 is the file name (step S242).

If the keyword attribute is the file name, the controller 300 (shortened expression voicing processor 306), from the list of character strings that is the result of the file narrowing down process in S132, omits the portion that matches the keyword (step S242; Yes→step S244). For example, when the keyword is “operation outsourcing agreement,” the controller 300 (shortened expression voicing processor 306) omits “operation outsourcing agreement” from the character string “support operation outsourcing agreement.doc” and makes the character string “support.doc”. Thereby, the controller 300 (shortened expression voicing processor 306) seeks an omitted expression of the file name.

The controller 300 (shortened expression voicing processor 306) may execute the processes of step S144 to step S152 of the first embodiment thereby to omit the predetermined character string (e.g., an extension) or, with the shortened expression duplicated, return to the original expression.

Next, the controller 300 (shortened expression voicing processor 306) executes the voicing process for voicing the shortened expression of the file name and the file number, based on the list of character strings (step S246). The process in step S246 is the same as the process in step S154 in the first embodiment.

If the keyword attribute is not the file name, the controller 300 (file name voicing processor 304) executes a voicing process for voicing the file number and the file name, based on the character string (file name) included in the list of character strings (step S242; No→step S248). The process in step S248 is the same as the process in step S156 in the first embodiment.

In this way, the controller 300 can execute a process in which, if the keyword attribute is the file name, a response is voiced with the portion that does not match the keyword as an option, and if the keyword attribute is not the file name, the file name is voiced as an option.

In addition to the methods described above, the controller 300 may switch the voicing content according to the keyword attribute. For example, in step S248, if the keyword attribute is the date-and-time, the controller 300 (file name voicing processor 304) may cause a voicing including the specific date-and-time indicated by the keyword.

Even when the keyword attribute is not the file name, the controller 300 may cause the shortened expression of the file name to be voiced in step S248 by executing step S144 to step S154 in the first embodiment. In addition, in step S246, the controller 300 may further execute steps S144 to S152 of the first embodiment thereby to further omit the file name's portion that does not match the keyword.

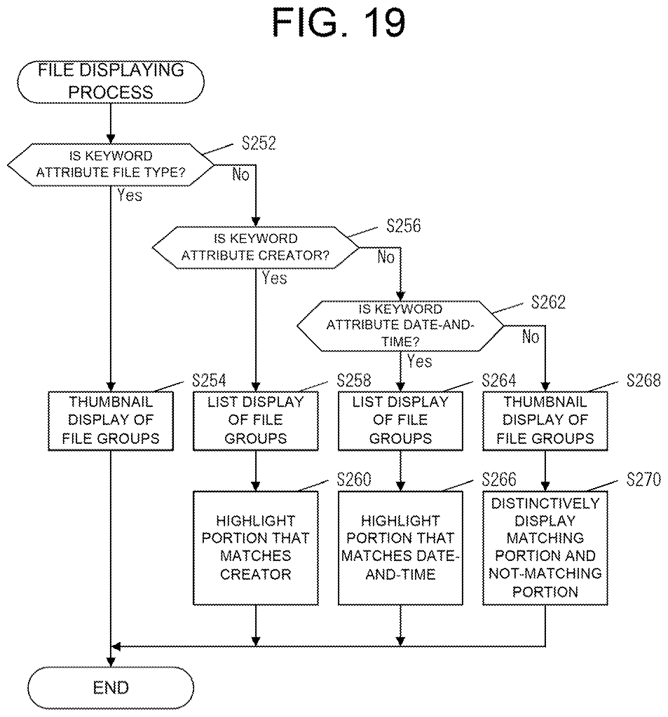

Returning to FIG. 16, from the dialogue server 30 to the voice recognition server 20, the file name voicing process in S134 sends the voicing text data indicating the voicing content (S135). To the voice inputter/outputter 10, the controller 200 of the voice recognition server 20 sends the voice signal of the synthesized voice which is based on the received voicing text data. Then, the controller 400 of the image former 40 executes a file displaying process to display the file based on the result of the file narrowing down process (S206). The file displaying process will be explained with reference to FIG. 19.

At first, the controller 400 determines whether or not the keyword attribute received in S204 is a file type (step S252). If it is the file type, the controller 400 causes the display 450 to display a thumbnail image of the file groups narrowed down in S132 (step S254; Yes→step S254). For example, the controller 400 executes a process similar to step S136 in the first embodiment thereby to display, on the display 450, a thumbnail image which corresponds to the file type.

If the keyword attribute is not the file type, the controller 400 determines whether or not the keyword attribute is the creator (step S252; No→step S256). If the keyword attribute is the creator, the controller 400 displays, on the display 450, the file groups in a list (step S256; Yes→step S258). The list display refers to display, in a list format, file information such as file name, file type, updated date-and-time, and creator, as well as file number.

In addition, for the creators included in the list display, the controller 400 highlights the portion that matches the keyword (step S260). As a highlight, for example, for the portion that matches the keyword, the controller 400, highlights or reverses the display, or displays the character thicker than the portion that does not match the keyword. The highlight may be a display in which the user can distinguish the character string that matches the keyword, in which the color of the character that matches the keyword is different from the color of the character that does not match the keyword, or in which the character that matches the keyword blinks.

If the keyword attribute is not the creator, the controller 400 determines whether or not the keyword attribute is the date-and-time (step S256; No→step S262). If the keyword attribute is date-and-time, the controller 400 displays, on the display 450, the file groups in a list (step S262; Yes→step S264). In addition, for the updated date-and-time included in the list display, the controller 400 highlights the portion that matches the date-and-time indicated by the keyword (step S266).

If the keyword attribute is not the date-and-time, the keyword is the file name. In this case, the controller 400 causes the display 450 to display thumbnail images of the file groups narrowed down in S132 (step S262; No→step S268). For example, the controller 400 executes a process similar to step S136 in the first embodiment thereby to display, on the display 450, a thumbnail image which corresponds to the file type.

Further, the controller 400 displays, on the display 450, the file name of the file which corresponds to the thumbnail image, and causes the displayed file name to be highlighted (distinctively displayed) in different modes so that, of the displayed file name, the portion that matches the keyword and the portion that does not match the keyword can be respectively distinguished (step S270). For example, the controller 400 displays, with highlight, the portion where the file name and the keyword match, and displays, in red character, the portion where the file name and the keyword do not match. In this case, the controller 400 may cause the extension's portion to be displayed in a normal mode.

Returning to FIG. 16, the dialogue server 30 receives, from the voice recognition server 20, the recognition result including the second voice (S137). The dialogue server 30 and the image former 40 identify the file based on the operation by the user (S138). In addition, the image former 40 executes output of an image which is based on the identified file (S140).

Although it has been explained that the dialogue server 30 in S204 sends the keyword and the keyword attribute to the image former 40, the dialogue server 30 may send, to the image former 40, the information indicating the display mode, instead of sending the keyword and the keyword attribute. For example, if the keyword attribute determined in S128 is the file type, the controller 300 sends, to the image former 40, information for displaying a thumbnail image which corresponds to the file type. If the keyword attribute determined in S128 is the file creator or the date-and-time, the controller 300 displays, in a list, the result of the file narrowing down process, and sends, to the image former 40, the information for highlighting the character string that matches the keyword. The controller 400 of the image former 40 displays the file, based on the information indicating the display mode received from the dialogue server 30. In this way, the dialogue server 30 can control the image former 40 to switch to the display mode which corresponds to the keyword attribute.

2.3 Operation Example

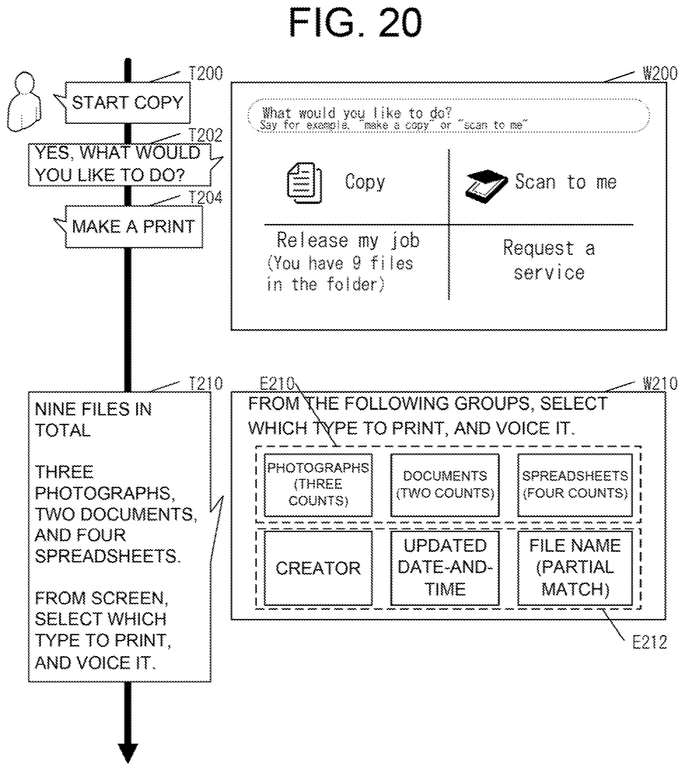

Next, an operation example in the present embodiment will be explained. At first, referring to FIG. 20, the process of presenting the summary and the narrow-down item name to the user is described. When a wake word T200 is voiced by the user, the screen displayed on the display 450 switches to a voice operation dedicated screen W200. At this time, a voice T202 which inquires the user about the function to be used is output from the voice inputter/outputter 10.

When a print instruction T204 is voiced by the user, a screen W110 including an area E210 in which the summary is displayed and an area E212 in which the narrow-down item name is displayed is displayed on the display 450. For example, in the example of FIG. 20, “creator”, “updated date-and-time”, and “file name (partial match)” are displayed as the narrow-down item name.

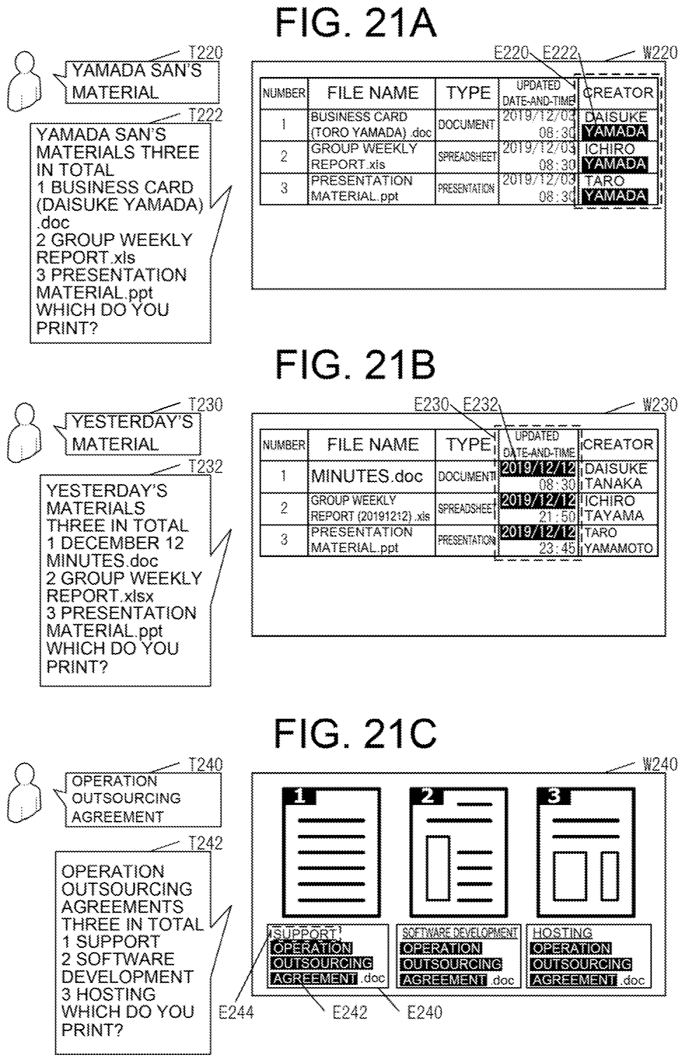

Next, referring to FIGS. 21A to 21C, the screen displayed on the display 450 and the voice output by the voice inputter/outputter 10 will be explained. FIG. 21A illustrates a case in which a voice T220 indicating the creator is voiced by the user. The display 450 displays a screen W220 in which file groups narrowed down based on the creator voiced by the user is displayed in a list. The screen W220 includes, for each file, an area E220 that displays the creator of the file, and further highlights the portion (e.g., area E222) where the creator and the keyword (creator) voiced by the user match.

From the voice inputter/outputter 10, as shown in a voice T222, the file name of the file narrowed down based on the keyword (creator) voiced by the user is voiced together with the file number.

FIG. 21B illustrates a case in which a voice T230 indicating the date-and-time is voiced by the user. The display 450 displays a screen W230 in which a file groups narrowed down based on the date-and-time voiced by the user is displayed in a list. A screen W230 includes, for each file, an area E230 that displays the date-and-time of the file (e.g., the updated date-and-time), and further highlights the portion (e.g., area E232) where the date-and-time and the date-and-time which is based on the keyword voiced by the user match.

From the voice inputter/outputter 10, as shown in a voice T232, the file name of the file narrowed down based on the keyword (date-and-time) voiced by the user is voiced together with the file number. At this time, a specific date-and-time indicated by the keyword may be voiced from the voice inputter/outputter 10. In this way, for example, when the user voices a voice such as “yesterday,” the specific date corresponding to the date of yesterday (e.g., December 12 if today is December 13) can be known via the voice output from the voice inputter/outputter 10.

FIG. 21C illustrates a case where a voice T240 indicating a part of the file name is voiced by the user. The display 450 displays a screen W240 in which thumbnail images and file names of the file groups narrowed down based on a part of the file name voiced by the user are displayed. On the screen W240, for each thumbnail image, an area (e.g., area E240) including the corresponding file name is displayed. In addition, concerning the file name, the portion that matches the keyword voiced by the user (e.g., area E242) and the portion that does not match the keyword voiced by the user (e.g., area E244) are highlighted in different methods.

Although the present embodiment has been explained as narrowing down the files based on the updated date-and-time of the files, the files may be narrowed down based on the creation date-and-time of the files, and it may be possible to set which of the creation date-and-time and the updated date-and-time is used to narrow down the files.

According to the present embodiment, based on voice dialogue, the user can narrow down, by creator/date-and-time/file name, the to-be-printed files, from among the plurality of stored files. In addition, the image former of the present embodiment, by highlighting the portion that matches the keyword, makes it easy for the user to select the file.

### 3. Third Embodiment

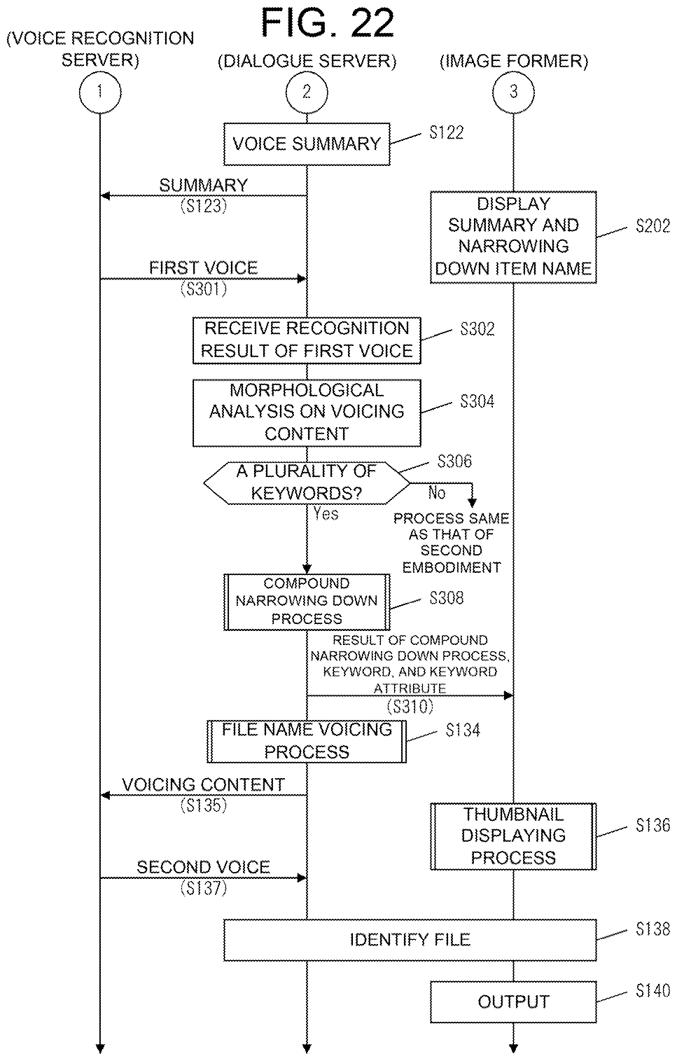

Next, a third embodiment will be explained. The third embodiment is an embodiment that can narrow down the files when a plurality of types of keywords are inputted. The present embodiment replaces FIG. 16 of the second embodiment with FIG. 22. The same numeral or symbol is attached to the same functional portion and process, and description thereof will be omitted.

3.1 Flow of Processes

The main process flow in the present embodiment will be explained with reference to FIG. 22. In the present embodiment, the dialogue server 30 and the image former 40 first execute the process shown in FIG. 8 in the first embodiment. The controller 300 (dialogue processor 302) of the dialogue server 30 executes the voicing process for voicing a summary which is based on the accumulated file information 334 (S122), and sends, to the voice recognition server 20, the voicing text data indicating the summary (S123). Next, the controller 300 receives the recognition result of the first voice from the voice recognition server 20, and executes the morphological analysis on the voicing content indicated by the recognition result (S301→S302→S304). The controller 300 divides the recognition result into words by executing the morphological analysis, and among the divided words, the word stored as keyword in the determination table 332 is acquired as keyword.

The controller 300 determines whether or not the acquired keyword is plural (S306). If the keyword is not plural, that is, if the keyword is singular (S306; No), the processes of S128 to S140 of the second embodiment, as shown in FIG. 16, are executed.

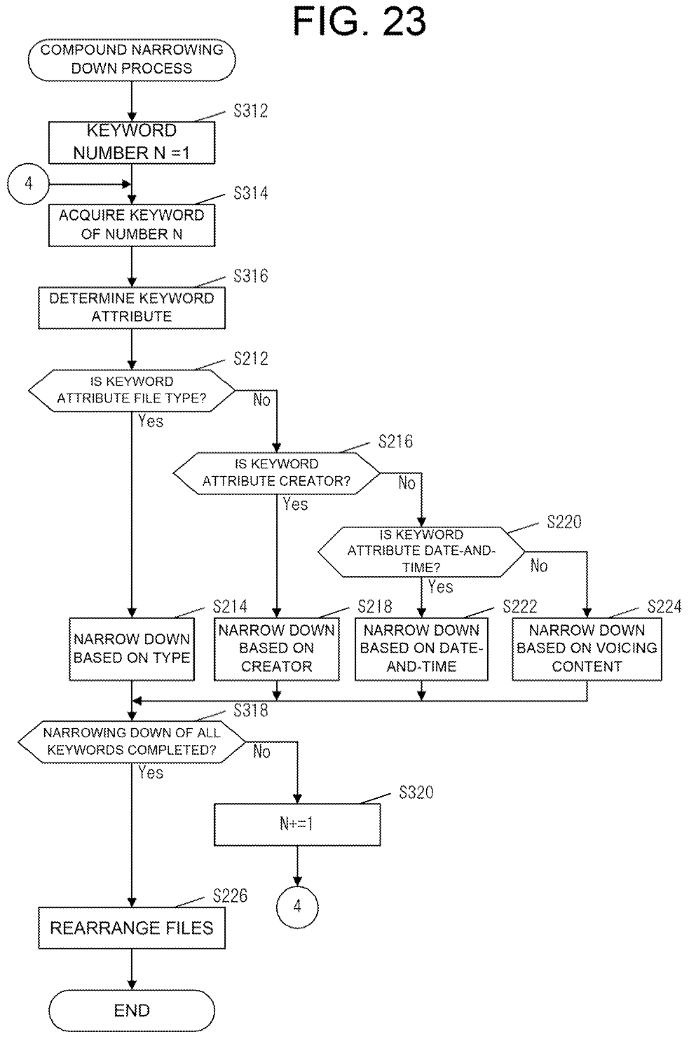

On the other hand, if there is a plurality of keywords, the controller 300, based on a plurality of conditions, narrows down the files to be presented to the user, and executes a compound narrowing down process that determines the order of the files to be presented to the user (S306; Yes→step S308). The compound narrowing down process will be explained with reference to FIG. 23.

At first, the controller 300 sets a number starting from 1 for an individual keyword included in the plurality of keywords, and assigns 1 to a variable N indicating the number set for the keyword (step S312). Next, the controller 300 acquires the keyword of the number N, and determines the keyword attribute (step S314→step S316). The method for determining the keyword attribute is the same as the process in S128 in the first embodiment.

Then, the controller 300 narrows down the files based on the keyword attribute. The process of narrowing down the files is the same as the processes in step S212 to step S224 in the second embodiment.

Next, the controller 300 determines whether or not the narrowing down of the files accumulated (stored) by all the keywords has been completed (step S318). When the narrowing down of the files by all the keywords is completed, the controller 300 rearranges the narrowed down files by a process similar to the process in step S226 of the second embodiment (step S318; Yes→step S226).

On the other hand, if the narrowing down of the files by all keywords has not been completed, the controller 300 adds 1 to the variable N, and returns to step S314 (step S318; No→step S320→step S314). When the controller 300 executes the processes of step S212 to step S224 again, the controller 300 further narrows down the target files that have been narrowed down until then. In this way, a compound search with a plurality of keywords is executed. The result of the compound narrowing down process is the information (e.g., the character string of file names) of the files arranged in the order of being presented to the user.

Returning to FIG. 22, the controller 300 sends, to the image former 40, the result of the compound narrowing down process in S308, the keyword, and the keyword attribute (S310). The result of the compound narrowing down process is the information on files arranged in the order of being presented to the user, similar to the result of the file narrowing down process, and is, for example, a list of file names (character strings).

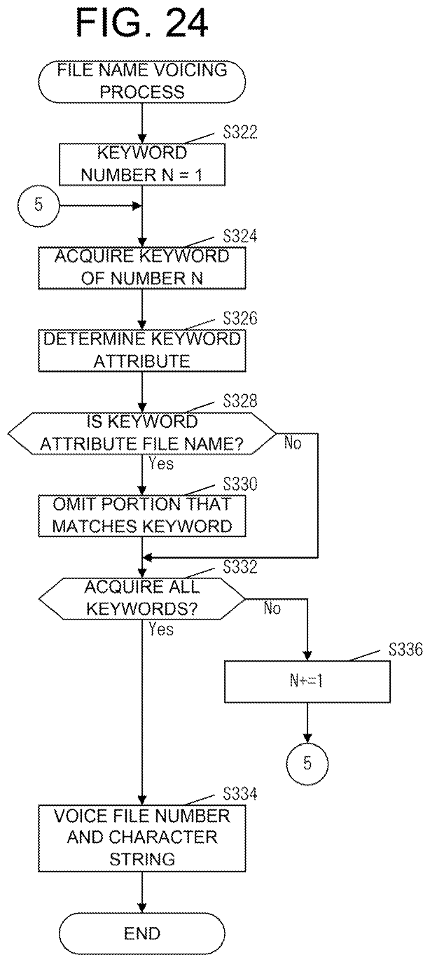

Next, the controller 300 executes the file name voicing process (S134). The flow of the file name voicing process in the present embodiment will be explained with reference to FIG. 24.

At first, the controller 300 (shortened expression voicing processor 306) sets a number starting from 1 for an individual keyword included in the plurality of keywords, and assigns 1 to the variable N indicating the number set for the keyword (step S322). Next, the controller 300 (shortened expression voicing processor 306) acquires the keyword of the number N, and determines the keyword attribute (step S324→step S326).

Next, when the keyword attribute of the number N is the file name, the controller 300 (shortened expression voicing processor 306) omits the portion, which matches the keyword of the number N, from the list of character strings that are the result of the compound narrowing down process in S306 (step S328; Yes→step S330).

Next, the controller 300 (shortened expression voicing processor 306) determines whether or not all the keywords have been acquired (step S332). If all the keywords have been acquired, the controller 300 (shortened expression voicing processor 306) executes a voicing process for voicing a shortened expression of the file name and the file number, based on the list of character strings (step S332; Yes→step S334). The process of step S334 is the same as the process of step S154 of the file name voicing process of the first embodiment. The controller 300 (shortened expression voicing processor 306), in step S334, may further execute steps S144 to S152 of the first embodiment, and thereby may further omit the file name's portion that does not match the keyword.

On the other hand, if the narrowing down of the files by all keywords has not been completed, the controller 300 adds 1 to the variable N, and returns to step S324 (step S332; No→step S336→step S324).

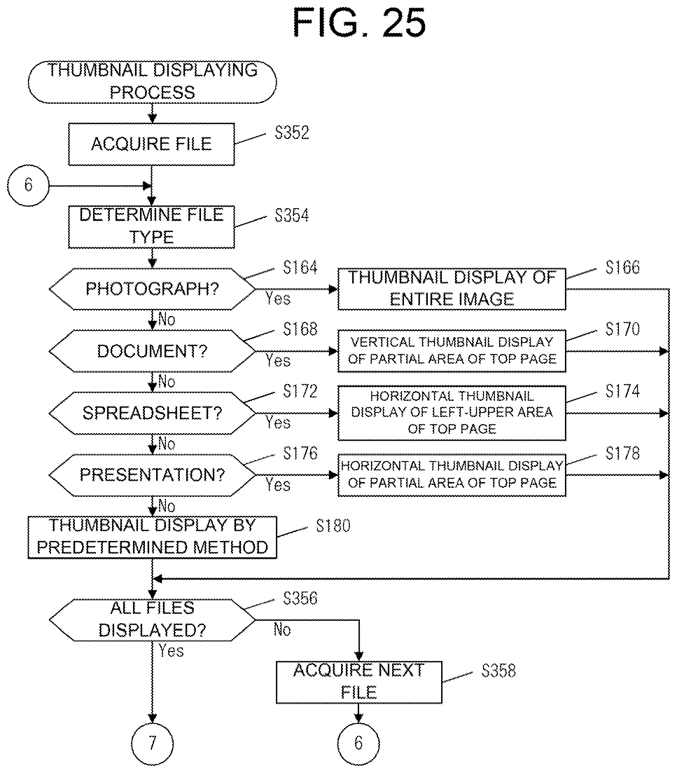

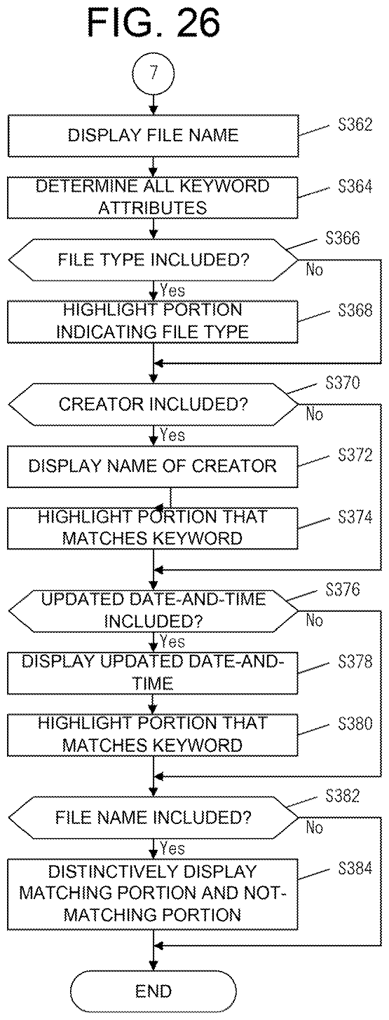

Returning to FIG. 22, the file name voicing process in S134 sends, from the dialogue server 30 to the voice recognition server 20, the voicing text data indicating the voicing content (S135). The controller 400 of the image former 40 executes the thumbnail displaying process (step S136). The thumbnail displaying process in the present embodiment will be explained with reference to FIG. 25 and FIG. 26.

At first, the controller 400 reads one piece of file information included in the result of the compound narrowing down process, and acquires a file which corresponds to the read file information (step S352).

Next, the controller 400 determines the file type acquired in step S332 (step S354), and displays the thumbnail image on the display 450 according to the file type. The method of displaying thumbnail images is the same as the method in step S164 to step S180 in the thumbnail displaying process of the first embodiment.

If the file type acquired in step S332 is a photograph, the controller 400 displays a thumbnail image in which the entire image of the above file is reduced (step S164; Yes→step S166). If the file type acquired in step S332 is a document, the controller 400 displays a vertical thumbnail image in which a partial area of the top page of the file is enlarged (step S164; No→step S168; Yes→step S170). If the file type acquired in step S332 is a spreadsheet, the controller 400 displays a horizontal thumbnail image in which the upper left area of the top page of the file is enlarged (step S168; No→step S172; Yes→step S174). If the file type acquired in step S332 is presentation, the controller 400 displays a horizontal thumbnail image in which a partial area of the top page of the file is enlarged (step S172; No→step S176; Yes→step S178). If the file type acquired in step S332 is a type other than the file types described above, the controller 400 displays a thumbnail image of the file by a predetermined method (step S176; No→step S180).

Next, the controller 400 determines whether or not the thumbnail images of all the files of the file group have been displayed (step S356). If the thumbnail images of all the files included in the file group are not displayed, the controller 400 acquires the next file of the file group, and returns to step S354 (step S356; No→step S358→step S354).

On the other hand, when the thumbnail images of all the files included in the file group are displayed (step S356; Yes), the controller 400 executes the process shown in FIG. 26.

The controller 400 displays, on the display 450, a corresponding file name for each thumbnail image (step S362). Next, the controller 400 determines the attributes of all keywords, based on the keyword attribute received from the dialogue server in S310 (step S364). Based on the determination in step S364, the controller 400 changes the display method of the file name displayed on the display 450.

First, the controller 400 determines whether or not the keyword attribute includes the keyword that is the file type (step S366). When the keyword attribute includes the keyword that is the file type, the controller 400, of the file names displayed in step S362, highlights a portion that indicates the file type (step S366; Yes→step S368). The portion that indicates the file type is, for example, the extension's portion.

Next, the controller 400 determines whether or not the keyword attribute includes the keyword that is the creator of the file (step S370). If the keyword attribute includes the keyword that is the creator, the controller 400 displays, on the display 450, the name of the creator of the above file, in addition to the file name (step S370; Yes→step S372). Further, the controller 400 highlights the portion that matches the keyword (step S374).

Next, the controller 400 determines whether or not a keyword whose attribute is an updated date-and-time is included (step S376). If the keyword whose attribute is the updated date-and-time is included, the controller 400 displays, on the display 450, the updated date-and-time of the above file, in addition to the file name (step S376; Yes→step S378). Further, the controller 400 highlights the portion that matches the date-and-time which is based on the keyword (step S380).

Next, the controller 400 determines whether or not a keyword whose attribute is a file name is included (step S382). When the keyword whose attribute is the file name is included, the controller 400 causes the file name displayed in step 362 to be highlighted (distinctively displayed) in different modes, so that, of the file name displayed in step 362, the portion that matches the keyword and the portion that does not match the keyword can be respectively distinguished (step S382; Yes→step S384).

Returning to FIG. 22, the dialogue server 30 receives, from the voice recognition server 20, the recognition result including the second voice (S137). The dialogue server 30 and the image former 40 identify the file based on the operation by the user (S138). In addition, the image former 40 executes output of an image which is based on the identified file (S140).

In the third embodiment, as in the second embodiment, in S310, the controller 300 of the dialogue server 30 may send information indicating the display mode, instead of sending the keyword and the keyword attribute to the image former 40. The information indicating the display mode includes information for displaying thumbnail images of files and information of character strings to be highlighted. The controller 400 of the image former 40 displays the thumbnail, based on the information indicating the display mode received from the dialogue server 30. In this way, the dialogue server 30 can control the image former 40 to switch to the display mode which corresponds to the keyword attribute.

3.2 Operation Example

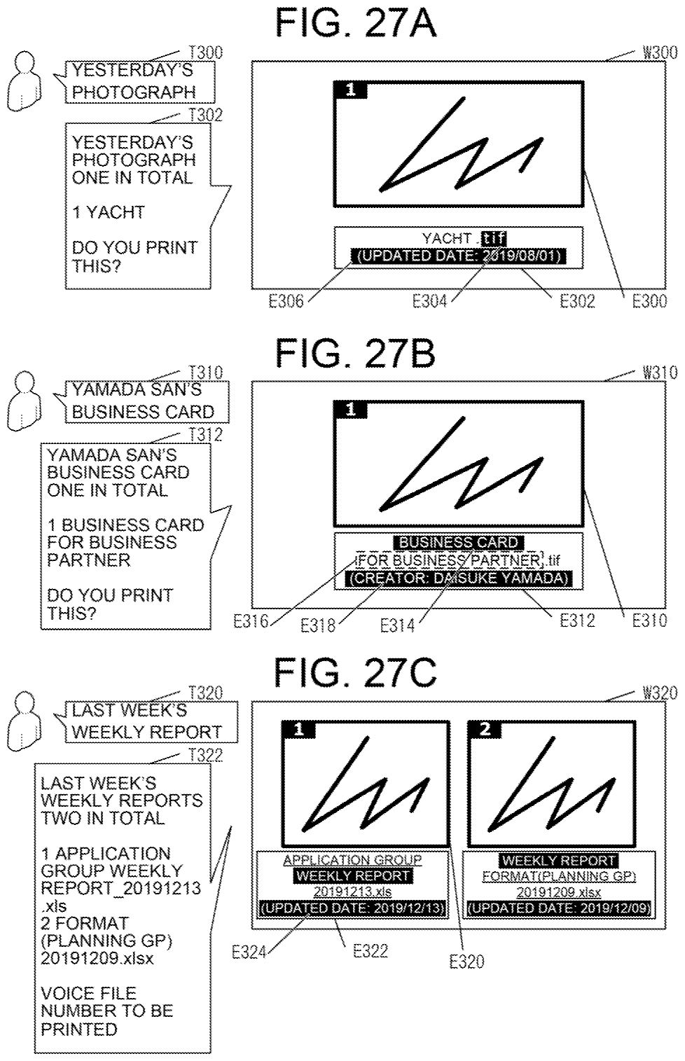

Next, an operation example in the present embodiment will be explained. FIG. 27A shows an operation example seen when a voice T300 such as “yesterday's photograph” is voiced by the user. A voice such as “yesterday's photograph” includes the keyword “yesterday” whose attribute is the updated date-and-time and “photograph” whose attribute is the file type. In this case, a screen W300 including thumbnail image of file group narrowed down based on the updated date-and-time and the file types is displayed on the display 450 of the image former 40. For example, as shown in FIG. 27A, the screen W300 includes a thumbnail image E300 and an area E302 including a file name.

Since the keywords based on the user's voicing include a keyword whose attribute is the file type, the extension's portion included in the file name is highlighted as shown in an area E304. Further, since the keywords include a keyword whose attribute is the updated date-and-time, the area E302 includes an area E306 where the updated date-and-time is displayed in addition to the file name, and the updated date-and-time is highlighted. The voice inputter/outputter 10 outputs a voice T302 that includes the file name and file number. When the attribute includes a keyword that is a file type, the file type is uniquely determined; therefore, the voice output from the voice inputter/outputter 10 may be a voice with the extension omitted from the file name.

FIG. 27B shows an operation example seen when a voice T310 such as “Yamada-san's business card” is voiced by the user. The voice such as “Yamada-san's business card” includes the keyword “Yamada” whose attribute is the creator, and “business card” whose attribute is the file name. In this case, a screen W310 including thumbnail images of file groups narrowed down based on the creator name and the file name is displayed on the display 450 of the image former 40. For example, as shown in FIG. 27B, the screen W310 includes a thumbnail image E310, and an area E312 which includes a file name.

The keywords based on the user's voicing include a keyword whose attribute is the file name. Therefore, as shown in an area E314 and an area E316, the file name's portion that matches the keyword and the file name's portion that does not match the keyword are highlighted in respectively different modes (distinctively displayed). Further, since the keywords include a keyword whose attribute is the creator, the area E312 includes, in addition to the file name, an area E318 where the creator's name is displayed, and the creator's name is highlighted. In addition, the voice inputter/outputter 10 outputs an omitted expression in which the file name's portion that matches the keyword input by the user is omitted. In the voice output from the voice inputter/outputter 10, the file name's portion that matches the keyword may or may not be omitted. The extension may or may not be omitted. When a compound search based on a plurality of keywords is executed, the portion to be omitted from the file name may be settable by a user, an administrator, and the like.

FIG. 27C shows an operation example seen when a voice T320 such as “last week's weekly report” is voiced by the user. A voice such as “last week's weekly report” includes the keyword “last week” whose attribute is the updated date-and-time, and “weekly report” whose attribute is the file name. In this case, a screen W320 including thumbnail images of file groups narrowed down based on the updated date-and-time and the file name is displayed on the display 450 of the image former 40. For example, as shown in FIG. 27C, the screen W320 includes a thumbnail image E320, and an area E322 including a file name.

Since the keywords based on the user's voicing include a keyword whose attribute is the updated date-and-time, as shown in the area E322, the area E322 includes, in addition to the file name, an area E324 in which the updated date-and-time is displayed, and the updated date-and-time is highlighted. In addition, since the keyword whose attribute is the file name is included, the file name's portion that matches the keyword and the file name's portion that does not match the keyword are highlighted in respectively different modes (distinctively displayed), as shown in area E322.

According to the present embodiment, the user can select a file after reducing as much as possible, by the compound search, the number of candidates for the output target file.

4. Variation

The present invention is not limited to each of the above embodiments, and various modifications can be made therefor. That is, any embodiment acquired by combining technical measures appropriately changed in the scope not departing from the gist of the present invention is also included in the technical scope of the present invention.

In each of the above embodiments, it has been described that the dialogue server 30 acquires the keyword based on the voice input by the user, but the keyword may be acquired by any other method. For example, the keyword may be acquired based on information input via an inputter (keyword or touch screen) available at the dialogue server 30 or the image former 40.

In addition, the program that operates in each device in the embodiments is a program that controls a CPU or the like (a program that causes a computer to function) in a manner to realize the functions of the above embodiments. Then, the information handled by these devices is temporarily stored in a temporary storage device (for example, RAM) at the time of processing the information, and then stored in various storage devices such as a ROM (Read Only Memory) and an HDD, and, as needed, is read, corrected, and written by the CPU.

Here, examples of a storage medium for storing the program may include a semiconductor medium (such as a ROM and a non-volatile memory card), an optical storage medium/magneto-optical storage medium (such as a Digital Versatile Disc (DVD), a Magneto Optical Disc (MO), a Mini Disc (MD), a Compact Disc (CD), and a Blu-ray Disc (BD) (registered trademark)), and a magnetic storage medium (such as magnetic tape and a flexible disk). In addition, the functions of the above embodiments are realized by executing a loaded program. In some cases, the functions of the present invention are realized by processing in collaboration with the operating system or another application program, based on the instructions of the program.

Further, in the case of distribution to the market, the program can be stored and distributed in a portable recording medium, or transferred to a server computer connected via a network such as the Internet. In this case, of course, a storage device of the server computer is also included in the present invention.

What is claimed is:

1. An information processor, comprising:
an acquirer that acquires a keyword recognized from an input first voice;
a narrower that narrows down a file by using the keyword;
a voicing processor that executes a process of voicing a voicing content which is based on the file narrowed down by the narrower; and
an identifier that identifies a file based on a second voice inputted after the voicing content is voiced.

2. The information processor according to claim 1, further comprising:
a determiner that determines a keyword attribute; and
a display controller that, according to the keyword attribute, executes a control to display the file narrowed down by the narrower.

3. The information processor according to claim 2, wherein when the keyword attribute is a file type, the display controller, according to the file type, executes control to display a thumbnail image of the file narrowed down by the narrower.

4. The information processor according to claim 3, wherein the display controller, when the file type is an image, executes a control to display the thumbnail image with a whole image reduced, whereas, when the file type is other than the image, executes a control to display the thumbnail image with a partial area of the file enlarged.

5. The information processor according to claim 2, wherein when the keyword attribute is a creator of a file or an updated date-and-time of a file, the display controller executes a control to display, in a list, information of the file narrowed down by the narrower, and executes a control to highlight and display a portion, of the information of the file, that matches the keyword.

6. The information processor according to claim 2, wherein the voicing processor, when the keyword attribute is a file name, executes a process of voicing a shortened expression of a file name of the file narrowed down by the narrower, and, when the keyword attribute is other than the file name, executes a process of voicing the file name of the file narrowed down by the narrower.

7. The information processor according to claim 1, wherein the voicing processor, when a time required for voicing a file name of the file narrowed down exceeds a predetermined time, determines that a shortened expression of the file name is to be voiced.

8. The information processor according to claim 1, wherein the voicing processor, when executing a process of voicing a shortened expression of a file name of the file narrowed down, makes the voicing content into a content in which a partial expression is omitted from the file name.

9. The information processor according to claim 8, wherein the voicing processor, based on a naming rule of the file name, omits the partial expression included in the file name.

10. The information processor according to claim 8, wherein the voicing processor, based on a feature of a language used for the file name, omits the partial expression included in the file name.

11. The information processor according to claim 8, wherein the voicing processor, when the file that includes the keyword in the file name is narrowed down, omits an expression that matches the keyword, from the file name of the file.

12. The information processor according to claim 1, wherein when there is a plurality of the keywords and the file including the keywords in the file name is narrowed down, the information processor omits, from the file name of the file narrowed down, an expression that matches the keywords.

13. The information processor according to claim 7, wherein when an expression resulting from omitting a partial expression from the file name is duplicated in file names of a plurality of the files, the voicing processor does not omit the duplicated file name.

14. The information processor according to claim 1, wherein the identifier identifies, among the files narrowed down, a file in which a file name includes a voicing content which is based on the second voice.

15. The information processor according to claim 1, wherein the voicing processor includes, in the voicing content, a number that corresponds to the file narrowed down, and
the identifier, when the number is included in the second voice, identifies a file that corresponds to the number.

16. A print system, comprising: an information processor; and an image former,
wherein the information processor includes:
an acquirer that acquires a keyword recognized from an input first voice,
a narrower that, by using the keyword, narrows down a file which the image former can output,
a voicing processor that executes a process of voicing a voicing content which is based on the file narrowed down by the narrower, and
a file identifier that identifies a file based on a second voice inputted after the voicing content is voiced,
wherein the image former includes:
a predetermined image former for forming an image of the file identified by the file identifier.

17. The print system according to claim 16, wherein the image former further includes a controller that, when the file that includes the keyword in the file name is narrowed down, executes a control to make distinctive display so that a portion of the file name of the file that matches the keyword is distinguishable from a portion of the file name of the file that does not match the keyword.

18. A control method, comprising:
acquiring a keyword recognized from an input first voice;
narrowing down a file by using the keyword;
executing a process of voicing a voicing content which is based on the file narrowed down; and
identifying a file based on a second voice inputted after the voicing content is voiced.
